(19) United States
(12) Patent Application Publication
(10) Pub. No.: US 2026/0081344 A1
(43) Pub. Date: Mar. 19, 2026

(54) WIRELESS EARBUD COMPRISING ANTENNA

(71) Applicant: LG ELECTRONICS INC., Seoul (KR)

(72) Inventors: Jeonghong LEE, Seoul (KR); Byongyol LEE, Seoul (KR); Sangheon LEE, Seoul (KR); Duckyun KIM, Seoul (KR); Junpil YUN, Seoul (KR)

(73) Assignee: LG ELECTRONICS INC., Seoul (KR)

(21) Appl. No.: 19/106,984

(22) PCT Filed: Nov. 30, 2022
(86) PCT No.: PCT/KR2022/019253

§ 371 Date: Feb. 26, 2025

(30) Foreign Application Priority Data
Sep. 7, 2022 (KR) 10-2022-0113598

(51) Int. Cl. H01Q 1/27; H01Q 1/38; H01Q 5/10; H01Q 5/314; H01Q 7/00; H04R 1/10

(52) U.S. Cl. CPC H01Q 1/27; H01Q 1/38; H01Q 5/10; H01Q 5/314; H01Q 7/00; H04R 1/10; H04R 2420/07

(57) ABSTRACT

This earbud comprises: a dielectric housing, which has a receiving space formed on the inside thereof; a printed circuit board (PCB), which is disposed in the receiving space of the dielectric housing and has a feeding terminal and at least one ground terminal provided thereon; an antenna pattern, which is disposed on the inner front surface of the dielectric housing; and a metal rim, which is formed on the outer front surface of the dielectric housing and has at least one ground connection part formed on the inside thereof. The antenna pattern may be connected to the feeding terminal on the PCB, and the at least one ground connection part of the metal rim may be connected to the at least one ground terminal on the PCB.

### TECHNICAL FIELD

The present disclosure relates to an electronic device and, more particularly, to an electronic device equipped with an antenna. A specific embodiment of the present disclosure relates to a wireless earbud equipped with an antenna and a control circuit.

### BACKGROUND ART

Electronic devices, such as accessories for mobile phones, computers, and other electronic equipment, may include a wireless circuit. For example, earbuds can be used as electronic devices that wirelessly communicate with mobile phones and other equipment.

Small-sized electronic devices, such as wireless earbuds, may be configured to receive reproduced content from mobile terminals, which are host devices, in a Bluetooth frequency band. Wireless earbuds correspond to wearable electronic devices that fit in the human ear

Problems may occur in realizing antennas and wireless communication circuits in small-sized devices, such as wireless earbuds. In this regard, an antenna enabling wireless signals to be radiated may not effectively operate within the main body of a wireless earbud worn on the human body. Therefore, this results in a problem where it is difficult to accomplish the desired performance in wireless communication with nearby electronic devices.

Wireless earbuds may be designed in such a manner as to receive wireless signals in a 2.4 GHz Bluetooth frequency band. An antenna provided in a wireless earbud to receive wireless signals may be arranged on a protruding portion, that is, a stalk portion, of the wireless earbud. In this regard, the length of the stalk portion of the wireless earbud is increased to account for the resonance length of an antenna operating in the 2.4 GH Bluetooth frequency band. The stalk portion of the earbud may be limited to a predetermined length based on design considerations related to the use of the earbud. Therefore, according to the present disclosure, an antenna design that can reduce the length of the antenna is required.

The operational bandwidth of the antenna provided in the wireless earbud needs to be designed to be broader than the operational bandwidths of other electronic devices that perform wireless communication in the Bluetooth frequency band. The reason for this is that an antenna resonance frequency changes due to a user's movement when the user wears the wireless earbud or due to the wireless earbud's movement within the ear canal.

In addition, the quality of wireless communication in the 2.4 GHz Bluetooth frequency band can be reduced depending on the surrounding environment of the user wearing the wireless earbud. In a case where the quality of wireless communication is reduced, reproduction of content, such as music, that is transferred to the wireless earbud through a host device may be delayed, or the quality of the content may be decreased. In order to address this problem, a wireless connection between the host device and the wireless earbud may also be needed in frequency bands other than the 2.4 GHz Bluetooth frequency band.

In addition, because existing earbuds need to operate exclusively in the Bluetooth frequency band, only a single resonance antenna in the 2.4 GHz Bluetooth frequency band has been designed. However, due to the integration of various applications (Wi-Fi, UWB, and others) into the earbud, there is a growing need for a multi-band design. Particularly, the internal region of the earbud has a structural limitation due to the small height between an antenna pattern and the ground. For this reason, it is not easy to expand a bandwidth, improve efficiency, and realize multi-resonance. Mobile terminals that use a metal rim as an antenna are possibly designed to have a multi-band structure by applying a slit and a stub line that are tailored for each frequency band. However, because the earbud features a compact internal space, there is a structural limitation on realizing a slit, a stub line, and the like, as is the case with mobile terminals.

### DISCLOSURE OF INVENTION

### Technical Problem

One object of the present disclosure is to address the above-mentioned and other related problems. Another object of the present disclosure is to provide a wireless earbud including an antenna structure in which an antenna space is reduced.

A further object of the present disclosure is to enable an antenna structure provided in a wireless earbud to operate a plurality of frequency bands.

Another object of the present disclosure is to increase an operational bandwidth of an antenna provided in a wireless earbud.

Still another object of the present disclosure is to reliably receive wireless signals despite changes in antenna resonance frequency while a wireless earbud is worn.

Yet another object of the present disclosure is to minimize changes in antenna performance caused by a small antenna arrangement space arranged within the mechanism of a wireless earbud.

Another object of the present disclosure is to receive voice content not only in the Bluetooth band but also in other bands, such as Wi-Fi and UWB bands, through a wireless earbud.

### Solution to Problem

In order to accomplish the above-mentioned and related objects, according to one aspect of the present disclosure, there is provided an earbud including: a dielectric housing having an internal surface that defines an accommodation space; a printed circuit board (PCB) arranged in the accommodation space in the dielectric housing and including a feeding terminal and at least one ground terminal; an antenna pattern arranged on the inward-facing portion of the internal surface of the dielectric housing; and a metal rim formed on the outward-facing portion of the external surface of the dielectric housing, at least one ground connection portion of the metal rim being formed on the internal surface of the metal rim. In the earbud, the antenna pattern is connected to the feeding terminal on the PCB, and the at least one ground connection portion of the metal rim is connected to the at least one ground terminal on the PCB.

In an embodiment, the dielectric housing may have an internal surface that defines the accommodation space, and an external surface that surrounds the internal surface. In addition, the external surface may be formed in a manner that is enabled to fit in a user's ear. In the earbud, a signal applied to the antenna pattern through the feeding terminal is radiated through an antenna structure including the antenna pattern and the metal rim.

In an embodiment, in the earbud, the metal rim formed to have a first length in one axial direction may be configured to resonate in a first frequency band. The antenna pattern formed to have a second length, smaller than the first length, in the one axial direction may be configured to resonate in a second frequency band broader than the first frequency band.

In an embodiment, in the earbud, the at least one ground terminal may include a first ground terminal and a second ground terminal that are formed at a first point and a second point, respectively, on the front surface of the PCB, the first point and the second point being spaced apart in one axial direction from each other. The at least one ground connection portion may include a first ground connection portion and a second ground connection portion that are formed at the first point and the second point, respectively, on the internal surface of the metal rim, the first point and the second point being spaced apart in the one axial direction from each other. The first ground terminal may be connected, at the first point, to the first ground connection portion. The second ground connection portion may be connected, at the second point, to the second ground connection portion.

In an embodiment, in the earbud, the metal rim may be formed in the shape of a closed loop. The first ground terminal and the second ground terminal may be formed on one side border region of the front surface of the PCB. The first ground connection portion and the second ground connection portion may be formed on one side region of the metal rim in the shape of the closed loop.

In an embodiment, in the earbud, the antenna pattern may be formed, in the shape of an open loop, to have a first end portion and a second end portion. The feeding terminal may be formed, at a third point, on the front surface of the PCB, the third point being spaced apart in the other axial direction from the first point. The feeding terminal may be connected, at the third point, to the first end portion of the antenna pattern in the shape of the open loop.

In an embodiment, in the earbud, the metal rim may include: a first loop formed, in a first curved-line shape, in an upper region in a manner that is positioned in the one axial direction above the first point to which the first ground terminal is connected; and a second loop formed, in a second curved shape, in a lower region in a manner that is positioned in the one axial direction below the first point. The first loop may be formed in such a manner that the maximum length thereof in the other axial direction is greater than the maximum length in the other axial direction of the second loop.

In an embodiment, in the earbud, the antenna pattern may be formed, in a third curved-line shape, in one portion of the lower region. The third curved-line shape of the antenna pattern may correspond to the second curved-line shape of the second loop in the one portion of the lower region, thereby enabling a signal from the antenna pattern to be coupled to the metal rim.

In an embodiment, in the earbud, the antenna pattern may include: a first sub-pattern formed to have a first straight-line length in the one axial direction, one end portion of the first sub-pattern being connected to the feeding terminal on the PCB; and a second sub-pattern formed to have a second straight-line length in the other axial direction, one end portion of the second sub-pattern being connected perpendicularly to the other end portion of the first sub-pattern. The antenna pattern may further include a third sub-pattern formed, in the third curved-line shape, to have a third straight-line, one end portion of the third sub-pattern being connected to the other end portion of the second sub-pattern. The one end portion of the first sub-pattern may correspond to the first end portion of the antenna pattern, and the other end portion of the third sub-pattern may correspond to the second end portion of the antenna pattern.

In an embodiment, in the earbud, the first ground connection portion and the second ground connection of the metal rim may be formed in such a manner that the distance therebetween in the one axial direction ranges from 0 mm to 4 mm. As the distance to the second ground connection portion increases, the resonance frequency of the antenna structure may increase.

In an embodiment, in the earbud, the first ground terminal may be directly connected to the first ground connection portion or be connected, at the first point, to the first ground connection portion, through a first matching element. The second ground terminal may be connected, at the second point, to the second ground connection portion through a second matching element.

In an embodiment, in the earbud, the first matching element connected to the first ground connection portion may be formed as a connection pattern with an impedance of 0 ohm. The second matching element connected to the second ground connection portion may be formed as an inductor with an inductance of 1 nH to 5 nH. As the inductance of the second matching element increases, the resonance frequency of the antenna structure may be decreased.

In an embodiment, in the earbud, the PCB may be formed to have a third length in the one axial direction. The metal rim in the shape of the closed loop may be formed to have a third length greater than the first length in the one axial direction. The lower end portion in the one axial direction of the metal rim may be formed in such a manner that the first low-end point thereon overlaps the second low-end point on the lower end portion in one axial direction of the PCB.

In an embodiment, the earbud may further include a battery arranged on the rear surface of the PCB and configured to supply electric power to electronic components within the earbud. The earbud may further include a speaker arranged behind the rear surface of the battery in the accommodation space in the dielectric housing and configured to reproduce voice content received from a paired electronic device. The earbud may further include a flexible printed circuit board (FPCB) connected to the PCB through the rear surface of the PCB and formed to surround the battery and the speaker.

In an embodiment, in the earbud, the FPCB may include a first accommodation space and a second accommodation space inside that are capable of accommodating the electronic components. A first microphone and a second microphone may be arranged in the first accommodation space and the second accommodation space, respectively. A control circuit on the PCB may convert voice signals, received through the first microphone and the second microphone, into wireless signals. The control circuit may perform control in such a manner that the wireless signals, resulting from the conversion, are radiated through the feeding terminal and through the antenna structure including the antenna pattern and the metal rim, and thus that the wireless signals, resulting from the conversion, are transferred to the paired electronic device.

According to another aspect of the present disclosure, there is provided an earbud including: a dielectric housing including a main body having a port and a protruding portion extending from the main body; a printed circuit board (PCB) arranged in an accommodation space in the dielectric housing and including a feeding terminal and at least one ground terminal; and a metal rim formed on the inward-facing portion of the internal surface of the dielectric housing or on the outward-facing portion of the external surface thereof, and connected to the feeding terminal and the at least one ground connection portion. In the earbud, the at least one ground connection portion of the metal rim is connected to the at least one ground terminal on the PCB. In the earbud, a signal applied to the metal rim through the feeding terminal is radiated through an antenna structure formed as the metal rim.

In an embodiment, in the earbud, the metal rim may include: a first sub-pattern formed to have a first pattern length in one axial direction, one end portion of the first sub-pattern being connected to the feeding terminal; a second sub-pattern formed to have a second pattern length in the other axial direction, one end portion of the second sub-pattern being connected to the other end portion of the first sub-pattern; and a loop pattern connected to an end portion of the at least one ground connection portion and the other end portion of the second sub-pattern and formed in the shape of a closed loop. The first sub-pattern and the second sub-pattern may form a sub-pattern of the metal rim.

In an embodiment, in the electronic device, the loop pattern on the metal rim formed to have a first length in the one axial direction may be configured to resonate in a first frequency band. The sub-pattern on the metal rim formed to have a second length shorter than the first length in the one axial direction, and at least one region of the loop pattern may be configured to resonate in a second frequency band broader than the first frequency band. The at least one ground terminal may include a first ground terminal and a second ground terminal formed, at a first point and a second point, respectively, on the front surface of the PCB, the first point and the second point being spaced apart from each other in the one axial direction. The at least one ground connection portion may include a first ground connection portion and a second ground connection portion, formed at the first point P1 and the second point P2, respectively, on one lateral surface of the metal rim, the first point and the second point being spaced apart from each other in the one axial direction. The first ground terminal may be connected, at the first point, to the first ground connection portion. The second ground terminal may be connected, at the second point, to the second ground connection portion.

In an embodiment, in the electronic device, the metal rim may be formed in the shape of a closed loop. The first ground terminal and the second ground terminal may be formed on one side border region of the front surface of the PCB. The first ground connection portion and the second ground connection portion may be formed on one side region of the metal rim in the shape of the closed loop. The feeding terminal may be formed, at a third point, on the front surface of the PCB, the third point being spaced apart in the other axial direction from the first point. The feeding terminal may be connected, at the third point, to the one end portion of the first sub-pattern of the metal rim.

In an embodiment, in the electronic device, the metal rim may include: a first loop formed, in a first curved-line shape, in an upper region in a manner that is positioned in the one axial direction above the first point to which the first ground terminal is connected; a second loop formed, in a second curved shape, in a lower region in a manner that is positioned in the one axial direction below the first point, and a connection pattern connected to one point on the metal rim and arranged inward or outward from the second loop, in a manner that is spaced apart from the second loop. The metal rim may radiate a signal in a first frequency band, due to the first loop and the second loop, and may radiate a signal in a third frequency band broader than the first frequency band due to the connection pattern.

In an embodiment, the electronic device may further: an RF circuit operatively coupled to the antenna module and transferring a wireless signal in a specific frequency band to the antenna module. The electronic device may include a processor operatively coupled to the RF circuit and configured to control the RF circuit.

In an embodiment, in the electronic device, the processor may control the RF circuit in such a manner that a first wireless signal in a first frequency band is received through the antenna module. When the signal quality of the first wireless signal is determined to be at or below a threshold value, the processor may control the RF circuit in such a manner that a second wireless signal in a second frequency band broader than the first frequency band is received from a host device through the antenna module.

### Advantageous Effects of Invention

The technical effects of a wireless earbud equipped with the antenna structure described above are described as follows.

According to the present disclosure, the antenna structure with a reduced antenna space can be arranged within a housing of the wireless earbud. Consequently, a wireless signal containing content can be received.

According to the present disclosure, the antenna structure is enabled to operate in a plurality of frequency bands in an electronic device, such as the wireless earbud, thereby ensuring stable reception of a wireless signal even in changing environmental conditions.

According to the present disclosure, ground coupling is minimized using a separate metal rim structure as an antenna. Consequently, it is possible to expand the bandwidth and to improve the antenna efficiency.

According to the present disclosure, the antenna volume increases using the entire metal rim as a radiator. Consequently, it is possible to expand the bandwidth and to improve the antenna efficiency.

According to the present disclosure, through the use of the structure that includes a plurality of conductive patterns, it is possible for the antenna structure to perform multi-resonance.

According to the present disclosure, the effective volume of the antenna is increased by forming an external radiation structure in the shape of a metal rim in such a manner as to surround an antenna pattern. Consequently, the bandwidth characteristic of the antenna can be improved.

According to the present disclosure, the effective volume of the antenna is increased by forming an external radiation structure in the shape of a metal rim in such a manner as to surround the antenna pattern. Consequently, the efficiency characteristic of the antenna can be improved.

According to the present disclosure, the effective volume of the antenna is increased by forming a sub-pattern on a radiation structure in the shape of a metal rim. Consequently, the bandwidth characteristic of the antenna can be improved.

According to the present disclosure, the effective volume of the antenna is increased by forming the sub-pattern on the radiation structure in the shape of a metal rim. Consequently, the efficiency characteristic of the antenna can be improved.

According to the present disclosure, a resonance frequency and impedance matching can be independently by applying a plurality of ground terminals.

According to the present disclosure, a welding process for metal rim contact is not required. Consequently, an assembly process can be simplified.

According to the present disclosure, the antenna structure can be configured to operate in a broadband frequency band in an electronic device, such as the wireless earbud.

While the wireless earbud is worn on a user's ear, an antenna resonance frequency changes when the user moves or the wireless earbud moves in the cavity in the user's ear. According to the present disclosure, in this case, a wireless signal can be stably received.

According to the present disclosure, a change in antenna performance, which is caused by a small antenna arrangement space arranged within the mechanism of the wireless earbud, can be minimized. Consequently, wireless communication performance can be stably maintained.

According to the present disclosure, voice content can be received not only in the Bluetooth band but also in other bands, such as Wi-Fi and UWB bands, through a wireless earbud.

An additional scope of applicability of the present disclosure would be apparent from the description detailed below. However, various modifications and alterations to the present disclosure within the scope of its technical idea would be clearly understandable to a person of ordinary skill in the art. Therefore, it should be noted that the detailed description and specific embodiments, such as preferred embodiments of the present disclosure, are provided in an exemplary manner.

### BRIEF DESCRIPTION OF DRAWINGS

FIG. 1 is a block diagram illustrating the configuration of an exemplary system that includes an electronic device wirelessly communicating with a wearable electronic device, such as a wireless earbud according to the present disclosure.

FIGS. 2 and 3 are perspective views that illustrate an earbud according to the present disclosure, when viewed from the front and when viewed from the rear, respectively.

FIG. 4 is a set of perspective and lateral views that illustrate the external structure of the earbud according to the present disclosure.

FIGS. 5A to 5C are lateral views, each illustrating a structure in which an antenna structure provided in the earbud according to the present disclosure is connected to terminals on a PCB.

FIG. 6 is a perspective view illustrating the structure in which the antenna structure in FIG. 5A is connected to the terminals on the PCB, and FIG. 7 is a perspective view illustrating the structure in which the antenna structure in FIG. 5B is connected to the terminals on the PCB.

FIG. 8 is a set of views that are referenced to conceptually describe the effective volume of the antenna structure according to the present disclosure and to compare the antenna structures.

FIG. 9 is a set of graphs that are referenced to compare the VSWR and efficiency characteristics of the antenna structures in FIG. 8.

FIG. 10 is a set of views and graphs that illustrate a first antenna structure realized as a loop antenna, the antenna structure realized as an antenna pattern, and a metal rim according to the present disclosure, and the VSWR performances of these structures.

FIG. 11 is a set including views and a graph that illustrate antenna structures formed with metal rims and connection patterns, and the VSWR characteristics of the antenna structures.

FIG. 12 is a set of views that illustrate different antenna structures formed by the metal rims in FIG. 11.

FIGS. 13A and 13B are views, each illustrating a structure in which the antenna structure is connected to ground terminals on the PCB through an impedance matching element.

FIG. 14 is a set of graphs that illustrate the VSWR characteristic which varies with the distance between the antenna structure and a ground connection portion, and the VSWR characteristic which varies with an inductance value of a second matching element.

FIG. 15 is a set including a graph and a view that illustrate the VSWR characteristic and impedance characteristic of the antenna structure that vary with a type of first matching element.

FIG. 16A is a view illustrating other electronic components and a coupling structure that are arranged within the earbud equipped with the antenna structure in FIG. 6, and FIG. 16B is a view illustrating other electronic components and a coupling structure that are arranged within the earbud equipped with the antenna structure in FIG. 77.

FIG. 17A is a perspective view illustrating the earbud equipped with the antenna structure in FIG. 16A, and FIG. 17B is a perspective view illustrating the earbud equipped with the antenna structure in FIG. 16B.

FIG. 18 is a view illustrating the configuration of an electronic device equipped with an antenna module according to the present disclosure and the configuration of the antenna module.

### MODE FOR THE INVENTION

Embodiments disclosed in the present specification will be described in detail below with reference to the accompanying drawings. Regardless of figure numbers, the same or similar constituent elements are assigned the same reference number and descriptions thereof are not repeated. The terms ‘module’ and ‘unit’ are hereinafter interchangeably or individually used to refer to a constituent element only for convenience in description in the present specification. Therefore, they are not intended by themselves to convey different meanings or to depict different functions. In addition, when describing the embodiments disclosed in the present specification, detailed descriptions of related well-known technologies will be omitted if it is determined that they would obscure the nature and gist of the present disclosure. In addition, the accompanying drawings are provided solely to facilitate understanding of the embodiments disclosed in the present specification. It should be understood that the technical idea disclosed in the present specification is not limited by the accompanying drawings. Furthermore, it should be understood that any alteration or equivalent of, or any substitute for, a constituent element according to the embodiment of the present disclosure, which falls within the scope of the technical idea of the present disclosure, is included within the scope of the present disclosure.

The ordinal numbers first, second, and so forth may be used to describe various elements, but they do not limit these elements. These ordinal numbers are only used to distinguish one element from another.

It should be understood that a constituent element, when referred to as ‘connected to’ or ‘having access to’ a different constituent element, may be directly connected to or have direct access to the different constituent element, or may be connected to or have access to the different constituent element, with a third constituent element in between. Likewise, it should be understood that a constituent element, when referred to as ‘directly connected to’ or ‘having direct access to’ a different constituent element, may be connected to or have access to the different constituent element without a third constituent element in between. A noun in singular form has the same meaning as when used in its plural form, unless it has a different meaning in context.

The term ‘include,’ ‘have,’ or the like in the present application is intended to indicate that a feature, a number, a step, an operation, a constituent element, a component, or a combination thereof, each of which is described in the specification, is present, and thus should be understood not to preclude the possibility that one or more other features, numbers, steps, operations, constituent elements, components, or combinations thereof may also be present or added.

An electronic device described in the present specification may be a wearable device. Wireless wearable electronic devices, such as wireless earbuds, may communicate with a host device and may communicate with each other. In this type of arrangement, arbitrarily chosen suitable types of host electronic devices and wearable wireless electronic devices may be used. In the present specification, as an example, the use of wireless hosts, such as cellular telephones, computers, or wristwatches, may be described depending on the context. In addition, an arbitrarily chosen suitable wearable wireless electronic device may wirelessly communicate with the wireless host. The use of the wireless earbud for communication with the wireless host is only exemplary.

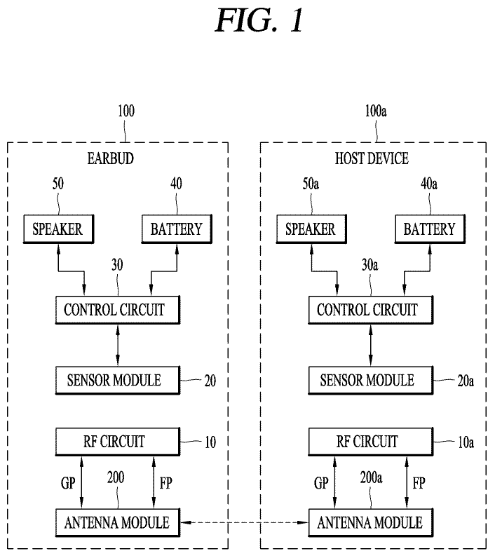

The wireless electronic device as a host may wirelessly communicate with an accessory device, such as the earbud. In this regard, FIG. 1 is a block diagram illustrating the configuration of an exemplary system that includes an electronic device wirelessly communicating with a wearable electronic device, such as a wireless earbud according to the present disclosure.

With reference to FIG. 1, a host electronic device 100a may be a mobile terminal capable of performing wireless communication or a wearable device that is different from the wireless earbud, but is not limited thereto. The host electronic device 100a may be realized as an arbitrary electronic device capable of performing wireless communication with the wireless earbud, or for example, as any one of the following: a computer, a laptop computer, a content reproduction device on a home network, or a vehicular communication device.

A wireless earbud 100 may be configured to include various constituent elements. In this regard, the wireless earbud 100 may be configured to include an antenna module 200, an RF circuit 10, and a sensor module 20. The wireless earbud 100 may be configured to further include a control circuit 30, a battery 40, and a speaker 50. The host electronic device 100a may be configured to include an antenna module 200a and an RF circuit 10a in order to perform wireless communication with the earbud 100. The host electronic device 100a may be configured to further include a sensor module 20a, a control circuit 30a, a battery 40a, and a speaker 50a, but is not limited thereto. The host electronic device 100a may be configured to include more constituent elements than the earbud 100.

The antenna module 200 may be configured to receive a wireless signal containing voice content from the host electronic device 100a. The antenna module 200 may be configured to receive a wireless signal in the Bluetooth band, for example, in a band ranging from 2.4 to 2.488 GHz, from the host electronic device 100a. In this regard, a wireless communication link between the host electronic device 100a and the earbud 100 is not limited to Bluetooth communication. An arbitrary wireless communication link, for example, a short-range wireless communication link in a frequency band of 2.4 GHz, 5 GHz, or the like, that is capable of supporting short-range wireless communication between the host electronic device 100a and the earbud 100 may be used. A wireless communication link in a mobile communication frequency band that supports IoT wireless communication, or a wireless communication link in a millimeter-wave band may also be used according to the application.

In addition, when a user's input is applied using an operation button provided on the earbud 100, a control command may be transferred to the host electronic device 100a through the antenna module 200 in such a manner as to control reproduction, sound volume, or the like of the voice content. The antenna module 200a of the host electronic device 100a may receive, in the Bluetooth band, a wireless signal containing the control command.

The antenna module 200 may be operatively coupled to the RF circuit 10. The antenna module 200 may be connected to a signal pattern on the RF circuit 10 through a feeder FP. The antenna module 200 may be connected to a ground pattern on the RF circuit 10 through a ground connection portion GP. The RF circuit 10 may be configured to amplify, filter, and process a signal that is transmitted through the antenna module 200 and a signal that is received therethrough.

The sensor module 20 may be configured to include at least one sensor. The sensor module 20 may be configured to include a proximity sensor capable of sensing the user's motion and sensing whether or not the user is nearby, a touch sensor capable of sensing the user's input, a pressure sensor, and the like, but is not limited to these sensors. The sensor module 20 may also further include an acceleration sensor, a gyro sensor, and the like.

The control circuit 30 may be operatively coupled to the sensor module 20, the battery 40, and the speaker 50. The control circuit 30 may be configured to control the respective operations of the sensor module 20, the battery 40, and the speaker 50.

The battery 40 may be configured to supply power to various electronic components arranged within the earbud 100. The battery 40 may be configured to store power when receiving it from a charger and to supply it to various electronic components. The speaker 50 may be configured to reproduce voice content received from the host electronic device 100a.

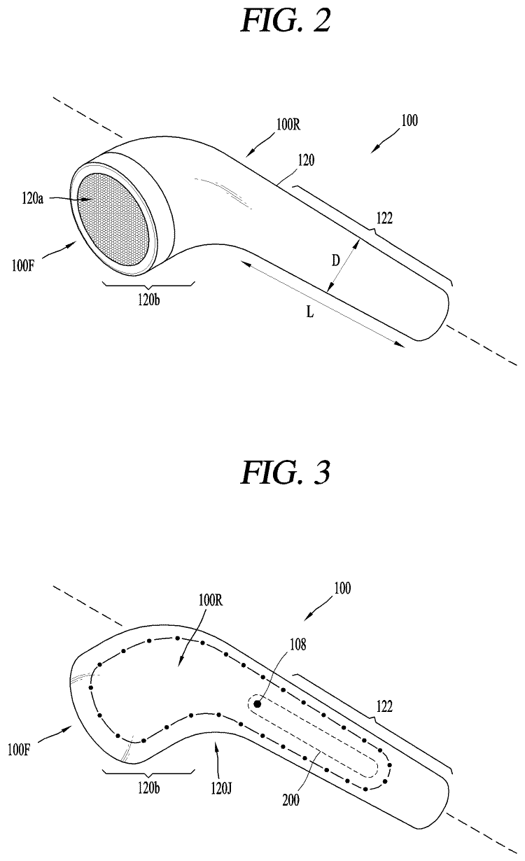

The earbud 100 according to the present disclosure may be configured in such a manner that it is formed in a mechanism structure with the form of a housing and that a port, such as a speaker port, is formed on the outside thereof. In this regard, the antenna module of the earbud 100, which is capable of receiving or transmitting a wireless sign, may be arranged within a housing. In this regard, FIGS. 2 and 3 are perspective views that illustrate the earbud according to the present disclosure, when viewed from the front and when viewed from the rear, respectively.

With reference to FIG. 2, which is the perspective view illustrating the earbud 100, when viewed from the front, the earbud 100 may be divided into a front surface 100F and a rear surface 100R with one axis in between. A housing 120 may include a main body portion 120b in which a speaker port 120a is formed. The speaker port 120a may be formed to face the front surface of the earbud 100. An elongated protruding portion, such as a stalk portion 122 of the housing 120, may extend outward from a main housing portion 120b. The stalk portion 122 may be formed as an elongated protruding portion having a predetermined L and diameter D.

The main body portion 120b may have a shape that appropriately fits in the user's ear. A speaker 20 may be mounted on the main body portion 120b and may align with the speaker port 120a. The speaker 20 may be used to propagate sound into the user's ear. The speaker port 120a may be formed from one or more openings in the housing 120. One or more plastic or metal mesh layers may be interposed between the housing 20 and the opening(s) 120.

The housing 120 may be formed of metal, plastic, a carbon fiber composite material, other fiber composite materials, glass, ceramics, other materials, or a combination of these. An elongated shape of the stalk 122 enables the user to grip the earbud 100 in his/her ear with his/her hand. The stalk 122 may extend from the main body portion 120b at the rear side 100R of the housing 120 and may extend along a stalk axis 120 in the lengthwise direction. According to the application, the stalk 122 may also be formed in a predetermined-type curved shape other than a straight-line shape.

FIG. 3 is a perspective view illustrating the earbud 100 in FIG. 2, when viewed from the rear. As illustrated in FIG. 3, an antenna 200 may have an elongated shape that extends along an axis in parallel to the length of the stalk 122. The antenna 200 may be formed to run from a feeder 108 up to the lower region of the stalk 122, but is not limited to this configuration.

With reference to FIGS. 1 to 3, the antenna 200 may overlap with structures such as a battery 26 and other conductive constituent elements that are positioned in an internal region 124 of the housing 120. These structures may be formed of a conductive material that tends to block the antenna 200.

The antenna feeder 108 may be positioned at a junction portion 12J of the housing 120 between the main body 120b and the stalk 122 instead of at a location that overlaps a region 124 of the main body 120b. Arranging the antenna feeder at a second position 108 rather than a first position 108′ may contribute to minimizing unnecessary radiation, occurring on a different ground plane, and power consumption. The first position 108′ is the same as that of the main body portion 120b, and the second position 108 is the same as that of a junction point 120J. Minimizing this unnecessary radiation and power consumption can reduce consumption of power in a battery and to improve antenna efficiency.

The antenna 200 may be formed as a metal pattern or a metal trace that is patterned on a printed circuit board (PCB). The PCB may be configured as a flexible printed circuit board (FPCB) (for example, a printed circuit formed in the shape of a sheet formed of a polyimide board material or another polymer board material) other than a board formed of a hard material.

A configuration is described below in which wireless communication with an electronic device outside the earbud is performed through an antenna structure arranged within the earbud according to the present disclosure. An electronic device outside the earbud may correspond to the host electronic device 100a in FIG. 1 and the earbud may correspond to the earbud 100 in FIG. 1. The earbud 100 may perform wireless communication with the host electronic device 100a through the antenna module 200. The earbud corresponds to a type of electronic device that receives content through wireless communication with the host electronic host. The earbud may be referred to as a true wireless stereo (TWS). A radiator structure arranged within the earbud that performs wireless communication with the host electronic device is described in detail.

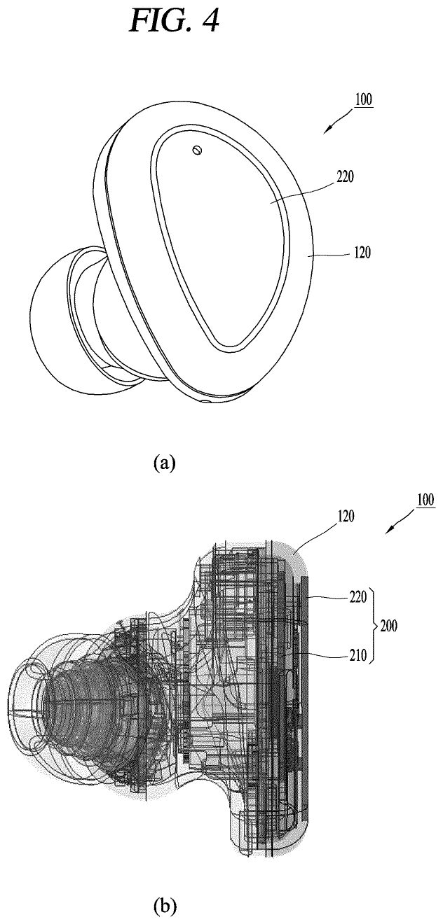

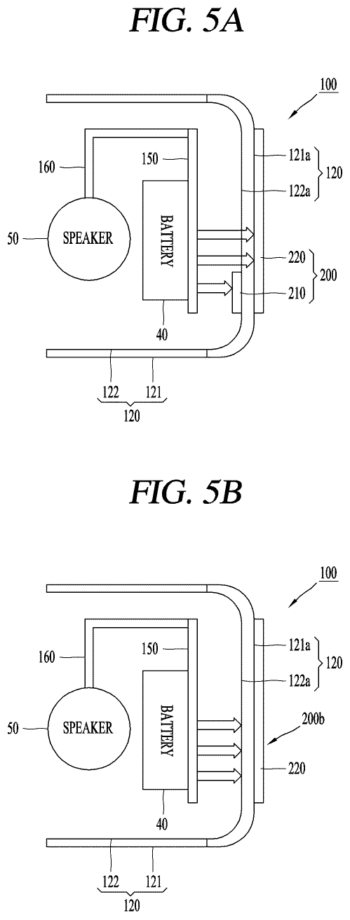

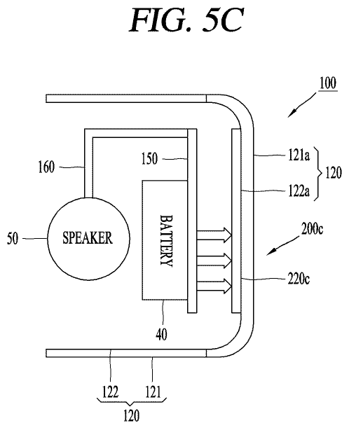

In this regard, FIG. 4 is a set of perspective and lateral views that illustrate the external structure of the earbud according to the present disclosure. FIGS. 5A to 5C are lateral views, each illustrating a structure in which the antenna structure provided in the earbud according to the present disclosure is connected to terminals on the PCB.

With reference to (a) of FIG. 4, the earbud 100 may be configured to include the dielectric housing 120 and a metal rim 220 formed on a surface of the dielectric housing 120. The dielectric housing 120 on which the metal rim 220 is arranged may be formed in a manner that can fit in the user's ear. The earbud 100 may be configured to reproduce voice content received from a paired external electronic device.

With reference to (a) and (b) of FIG. 4, an antenna structure 200 may be formed using the metal rim 220 and at least one conductive pattern on the inside of the dielectric housing 120. For example, an antenna pattern 210 formed on the internal surface of the dielectric housing 120 and the metal rim 220 formed on the external surface of the dielectric housing 120 may form the antenna structure 200.

With reference to FIG. 5A, an accommodation space may be defined by the internal surface 122 of the dielectric housing 120, and the external surface 121 may be formed in such a manner as to surround the internal surface 122. The external surface 121 of the dielectric housing 120 may be formed in a manner that can fit in the user's ear.

The PCB 150 may be arranged in the accommodation space defined by the internal surface 122 of the dielectric housing 120. The PCB 150 may include a feeding terminal 151 and ground terminals 152a and 152b. A battery 40 and a speaker 50 may be arranged in the accommodation space defined by the internal surface 122 of the dielectric housing 120. The speaker 50 may be connected to the PCB 150 through a flexible printed circuit board 160.

The antenna pattern 210 may be formed on the inward-facing portion 122a of the internal surface 122 of the dielectric housing 120. The metal rim 220 may be formed the outward-facing portion 121a of the external surface 121 of the dielectric housing 120. The antenna pattern 210 may be connected to the feeding terminal on the PCB 150. The metal rim 220 may be formed on the external surface 121 of the dielectric housing 120 or be formed in a manner that is inserted into the external surface 121 of the dielectric housing 120. The antenna pattern may be coupled to the PCB 150 through the feeding terminal. The antenna pattern 210 may be coupled to the PCB 150 through first and second ground terminals on the metal rim 220.

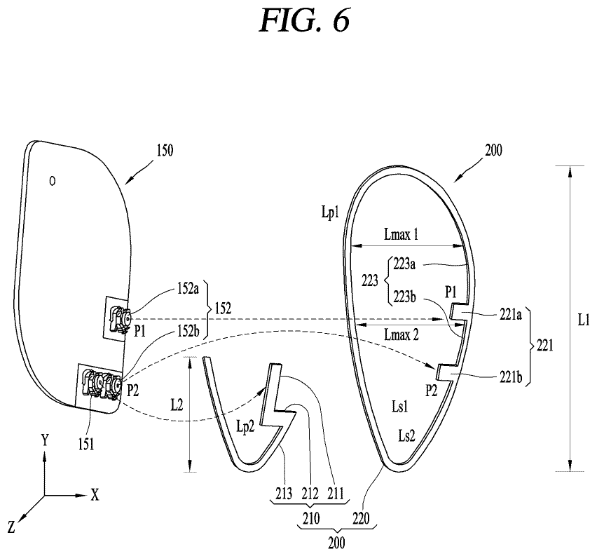

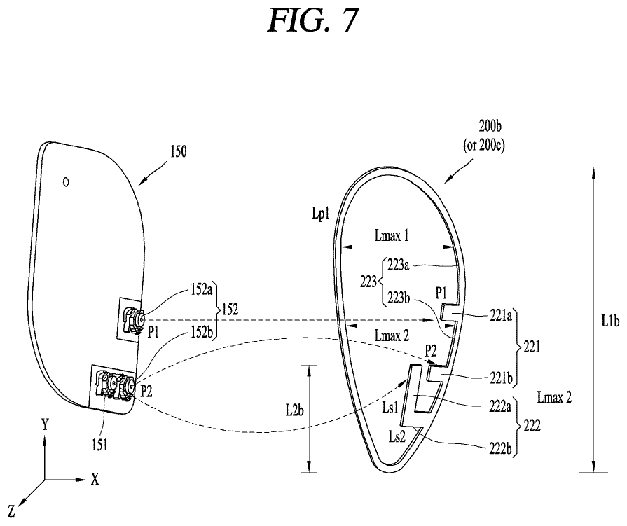

FIG. 6 is a perspective view illustrating the structure in which the antenna structure in FIG. 5A is connected to the terminals on the PCB, and FIG. 7 is a perspective view illustrating the structure in which the antenna structure in FIG. 5B is connected to the terminals on the PCB.

With reference to FIGS. 5A and 6, the antenna structure 200 may be configured as a stacked structure that includes the antenna pattern 210 and the metal rim 220. In this regard, the antenna pattern 210 and the metal rim 220 may be referred to as the first conductive pattern and a second conductive pattern, respectively, on the antenna structure 200. The antenna pattern 210 may be arranged on the inward-facing portion 122a of the internal surface 122 of the dielectric housing 120, and the metal rim 220 may be arranged on the outward-facing portion 121a of the external surface 121 of the dielectric housing 120. The battery 40 may be arranged on the rear surface of the PCB 150, and the PCB 150 may be connected to the speaker 40 through the FPCB 160. The feeding terminal 151 on the PCB 150 may be connected to a first sub-pattern 211 of the antenna pattern 210. The ground terminals 152a and 152b on the PCB 150 may be connected to ground connection portions 221a and 221b, respectively, of the metal rim 220. The antenna pattern 210 and the metal rim 220 are formed of metal and may be realized as FPCBs, metal plates, conducting prints, conductive paste, conductive patterns on plastic, or the like. The conductive pattern can be formed on plastic, using an engineering technique such as LMA or LMS.

With reference to FIGS. 5B and 7, a second antenna structure 200b may be configured as a single structure of the metal rim 220. In this regard, the metal rim 220 may be referred to as a conductive pattern, a radiative pattern, or an antenna pattern of the second antenna structure 200b. The metal rim 220 may be arranged on the outward-facing portion 121a of the external surface 121 of the dielectric housing 120. The feeding terminal 151 on the PCB may be connected to a first sub-pattern 222a of the metal rim 220. The ground terminals 152a and 152b on the PCB 150 may be connected to the ground connection portions 221a and 221b, respectively, of the metal rim 220.

With reference to FIGS. 5C and 7, a third antenna structure 200c may also be configured as a single structure of the metal rim 220. In this regard, the metal rim 220 may be referred to as a conductive pattern, a radiative pattern, or an antenna pattern of the third antenna structure 200c. A metal rim 220c may be arranged on the inward-facing portion 122a of the internal surface 122 of the dielectric housing 120. The feeding terminal 151 on the PCB may be connected to the first sub-pattern 222a of the metal rim 220. The ground terminals 152a and 152b on the PCB 150 may be connected to ground connection portions 221a and 221b, respectively, of the metal rim 220c.

With reference to FIGS. 4 to 7, an antenna structure of the earbud according to the present disclosure is described in detail. The earbud 100 may include the dielectric housing 120, the printed circuit board (PCB) 150, and the antenna structure 200. The antenna structure 200 may be configured to include the antenna pattern 210 and the metal rim 220.

The external surface 121 of the dielectric housing 120 may be formed in a manner that can fit in the user's ear, and the accommodation space may be defined by the internal surface 122 thereof. The PCB 150 may be arranged in the accommodation space defined by the internal surface 122 of the dielectric housing 120. The PCB 150 may include the feeding terminal 151 and at least one ground terminal 152. For example, the PCB 150 may include the feeding terminal 151 and first and second ground terminals 152a and 152b.

The antenna pattern 210 may be formed on the inward-facing portion 122a of the internal surface 122 of the dielectric housing 120. The metal rim 220 may be formed the outward-facing portion 121a of the external surface 121 of the dielectric housing 120. At least one ground connection portion 221 may be formed on the internal surface of the metal rim 220. The antenna pattern 210 may be configured to include the first sub-pattern 211, a second sub-pattern 212, and a third sub-pattern 213. The metal rim 220 may be configured to include a first ground connection portion 221a and a second ground connection portion 221b.

The antenna pattern 210 may be connected to the feeding terminal 151 on the PCB. At least one ground connection portion 221 of the metal rim 220 may be formed on the internal surface 122 of the dielectric housing 120. In this regard, the metal rim 220 may be formed on the external surface 121 of the dielectric housing 120 or be formed in a manner that is inserted into the external surface 121 of the dielectric housing 120. At least one ground connection portion 221 connected, at a specific point, to the metal rim 220 may pass through the dielectric housing 120. Accordingly, at least one ground connection portion 221 may be connected to at least one ground terminal 152 on the PCB 150 arranged in the accommodation space within the dielectric housing 120.

With reference to FIGS. 4 and 7, the second antenna structure 200b of the earbud according to the present disclosure is described in detail. The earbud 100 may include the dielectric housing 120, the printed circuit board (PCB) 150 and the antenna structure 200b. The antenna structure 200b may be realized as the metal rim 220.

The dielectric housing 120 may include a main body portion 120b, having a speaker port, and a protruding portion 122, extending from the main body portion 120b. The external surface 121 of the dielectric housing 120 may be formed in a manner that can fit in the user's ear, and the accommodation space may be defined by the internal surface 122 thereof. The PCB 150 may be arranged in the accommodation space defined by the internal surface 122 of the dielectric housing 120. The PCB 150 may include the feeding terminal 151 and at least one ground terminal 152.

The metal rim 220 as the antenna structure 200b may be formed on the inward-facing portion 122a of the internal surface 122 of the dielectric housing 120 or on the outward-facing portion 121a of the external surface 121 thereof. The metal rim 220 may be connected to the feeding terminal 151 on the PCB 150 and at least one ground terminal 152. At least one ground connection portion 221 of the metal rim 220 may be connected to at least one ground terminal 152 on the PCB 150. A sub-pattern 222 of the metal rim 220 may be connected to the feeding terminal 151 on the PCB. A signal applied to the first sub-pattern 222a of the metal rim 220 through the feeding terminal 151 on the PCB 150 may be radiated through the antenna structure 200b formed as the metal rim 220.

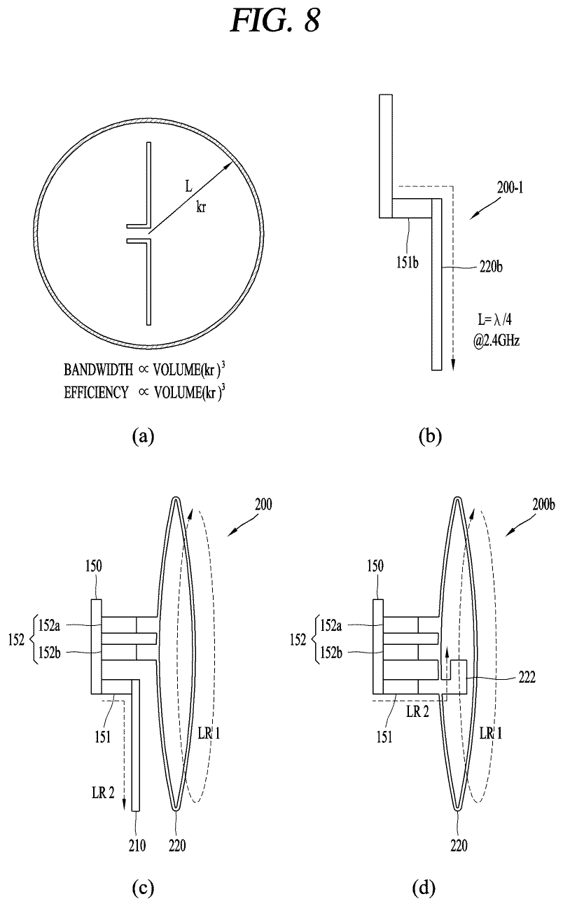

The signal applied through the feeding terminal 151 on the PCB 150 may be radiated through the antenna structures 200 and 200b. The antenna structures 200 and 200b may need to operate in a broadband frequency band in such a manner as to cover the entire frequency band. A signal applied to the antenna pattern 210 is radiated through the antenna structure 200 that includes the antenna pattern 210 and the metal rim 220. A signal applied to the metal rim 220 may be radiated through the antenna structure 200b realized as the metal rim 220. In this regard, FIG. 8 is a set of views that are referenced to conceptually describe the effective volume of the antenna structure according to the present disclosure and to compare the antenna structures.

With reference to (a) of FIG. 8, the antenna bandwidth characteristic and the antenna efficiency characteristic may be determined depending on the effective volume formed by the antenna. The effective volume may be determined by a distance r over which the near field of the antenna is formed. The effective volume of the antenna, which varies with the distance r, may be expressed as kr³ in the electrical unit. Therefore, the antenna bandwidth characteristic and the antenna efficiency characteristic may be proportional to the effective volume of the antenna. The resonant length of the antenna is inversely proportional to the length L of the antenna.

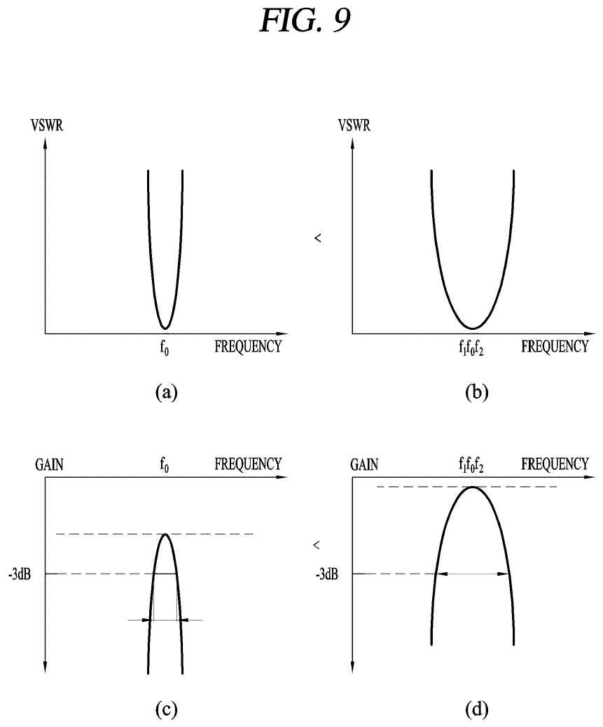

(b) of FIG. 8 illustrates the resonant length of a monopole antenna. (c) and (d) of FIG. 8 illustrate the resonant lengths of the antenna structures 200 and 200b. In this regard, FIG. 9 is a set of graphs that are referenced to compare the VSWR and efficiency characteristics of the antenna structures in FIG. 8.

The principle that the antenna bandwidth characteristic and the antenna efficiency characteristic are proportional to the effective volume of the antenna is not limited to the monopole antenna in (b) of FIG. 8, but also applies to an inverted-F antenna, the antenna structure 200 in (c) of FIG. 8, and the antenna structure 200b in (d) of FIG. 8. In this regard, the antenna performance may decrease when the antenna is realized in the limited space in the dielectric housing that corresponds to the main body portion of the earbud.

With reference to (b) of FIG. 8, a monopole antenna 200-1 may be configured to include a feeder 151b and an antenna pattern 220b. The feeder 151b may be configured to connect the PCB 150 and the antenna pattern 220b. The resonant length of the monopole antenna 200-1 may be determined as the sum of the length of the feeder 151b and the length of the antenna pattern 220b. In this regard, the antenna is not limited to the monopole antenna, but may be replaced with a dipole antenna or an inverted F antenna.

With reference to (c) of FIG. 8, the antenna structure 200 may be configured to include the antenna pattern 210 and the metal rim 220. The feeding terminal 151 on the PCB may be connected to the antenna pattern 210. The first and second ground terminals 152a and 152b on the PCB 150 may be connected to the metal rim 220. The antenna structure 200 may resonate in a first frequency band due to a first resonant length LR1 of the metal rim 220 in the shape of a closed loop. The antenna structure 200 may resonate in a second frequency band, broader than the first frequency band, due to a resonant length LR2 of both the feeding terminal 151 and the antenna pattern 210.

With reference to (d) of FIG. 8, the antenna structure 200b may be formed as a single structure of the metal rim 220. The feeding terminal 151 on the PCB may be connected to the sub-pattern 222 of the metal rim 220. The first and second ground terminals 152a and 152b on the PCB 150 may be connected to the metal rim 220. The second antenna structure 200b may resonate in the first frequency band due to the first resonant length LR1 of the metal rim 220 in the shape of a closed loop. The second antenna structure 200b may resonate in the second frequency band, broader than the first frequency band, due to the resonant length LR2 of both the feeding terminal 151 and the sub-pattern 222 of the metal rim 220.

With reference to (b) of FIG. 8 and (a) of FIG. 9, the voltage standing wave ratio (VSWR) of the monopole antenna 200-1 may be maintained at or below a threshold level, for example, at or below a value of 3, in the first frequency band including a resonance frequency f₀. With reference to (b) of FIG. 8 and (b) of FIG. 9, the antenna efficiency of the monopole antenna 200-1 may be maintained at or below a threshold level, for example, at or below a value of −3 dB, in the first frequency band including a resonance frequency f₀.

With reference to (c) and (d) of FIG. 8 and (c) of FIG. 9, the VSWRs of the antenna structures 200 and 200b may be maintained at or below the threshold level, for example, at or below a value of 3, in the first frequency band including a first frequency f₁, and in the second frequency band including a second frequency f₂. The first frequency f₁ may be configured to be lower than the resonance frequency f₀, and the second frequency f₂ may be configured to be higher than the resonance frequency f₀. In this regard, the resonance frequency f₀ may be 2.45 GHz, which is the center frequency of the Bluetooth (BT)/Wi-Fi frequency band. The first frequency f₁may be configured to be lower than 2.45 GHz. The second frequency f₂ may be configured to be higher than 2.45 GHz. For example, the first frequency f₁ and the second frequency f₂ may be configured to be 2.3 GHz and 2.6 GHz, respectively. The first frequency band and the second frequency band may be configured as a frequency band having the center frequency of 2.3 GHz and a frequency band having the center frequency of 2.6 GHz, respectively.

With reference to (c) and (d) of FIG. 8 and (d) of FIG. 9, the antenna efficiency of the antenna structure 200 may be maintained at or below the threshold level, for example, at or below a value of −3 db in the first frequency band including the first frequency f₁, and the second frequency band including the second frequency f₂. In this regard, the broader the operational bandwidth of the antenna structure, the more the transmission speed of content is improved, and the more the influence of a wireless signal to the body of the user who wears the earbud is decreased.

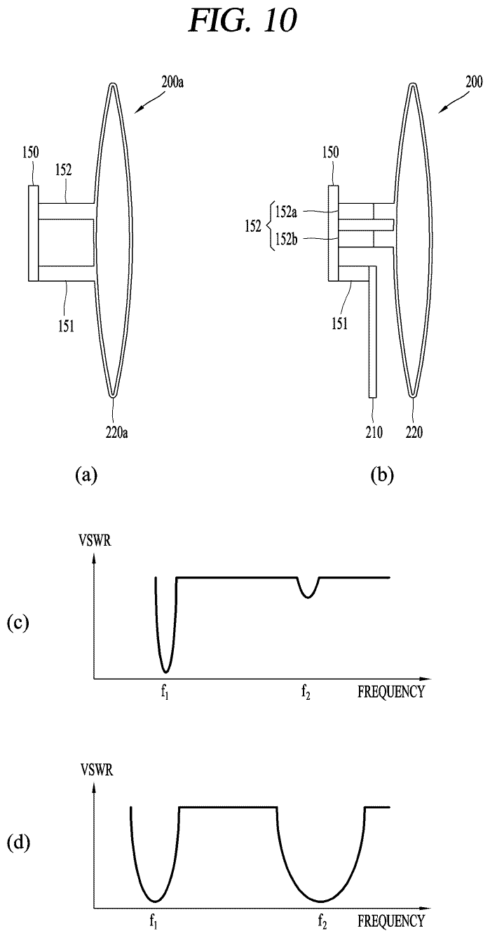

The antenna pattern 210 of the antenna structure 200 according to the present disclosure is realized as a monopole/dipole antenna, and the metal rim 220 is realized as a loop antenna. In this regard, FIG. 10 is a set of views and graphs that illustrate a first antenna structure 200a realized as a loop antenna, the antenna structure realized as the antenna pattern, and the metal rim according to the present disclosure, and the VSWR performances of these structures.

With reference to (a) of FIG. 10, the first antenna structure 200a may include the feeding terminal 151, connected to the PCB 150, the ground terminal 152, and the conductive pattern 220b in the shape of a loop. Multi-resonance is not easy to achieve with the first antenna structure 200a realized as the conductive pattern 220b in the shape of a loop in (a) of FIG. 10.

With reference to (a) and (b) of FIG. 10, the first antenna structure 200a has a VSWR, which is at or below a threshold value, at the first frequency f₁, due to the conductive pattern 220b in the shape of a loop. Therefore, the first antenna structure 200a may resonate in the first frequency band, with the first frequency f₁ at the center thereof, due to the conductive pattern 220b in the shape of a loop. The first antenna structure 200a has a VSWR, which is at or above the threshold value, at the second frequency f₂. Therefore, the first antenna structure 200a may not operate, as a radiator, in the second frequency band including the second frequency f₂.

With reference to (c) of FIG. 10, the antenna structure 200 may include the feeding terminal 151, connected to the PCB 150, the first and second ground terminals 152a and 152b, the antenna pattern 210, and the metal rim 220, which is a conductive pattern in the shape of a loop. The second antenna structure 200 in (c) of FIG. 10, which is realized as the antenna pattern 210 in the shape of a monopole or dipole and the metal rim 220 in the shape of a loop, may generate multi-resonance.

With reference to (c) and (d) of FIG. 10, the antenna structure 200 has a VSWR, which is at or below the threshold value, at the first frequency f₁, due to the metal rim 220 in the shape of a closed loop. Therefore, the antenna structure 200 may resonate in the first frequency band, with the first frequency f₁ at the center thereof, due to the metal rim 220 in the shape of a loop. In addition, the antenna structure 200 may resonate in the second frequency band, with the second frequency f₂ at the center thereof, due to the antenna pattern 210 in the shape of a monopole/dipole. Therefore, the second antenna structure 200 possibly generates multi-resonance because two radiative patterns, the antenna pattern 210 and the metal rim 200, operate independently. The antenna structure 200 has a high VSWR, which is at or below the threshold value, at the second frequency f₂. Therefore, the antenna structure 200 may operate, as a multi-resonance radiator, the first frequency band including the first frequency f₁, and the second frequency band including the second frequency f₂.

With reference to FIGS. 4 to 10, the earbuds 100 equipped with the antenna structures 200 and 200b according to the present disclosure are described below. The metal rim 220 formed to have a first length L1 in one axial direction may be configured to resonate in the first frequency band. In this regard, a first loop length Lₚ₁ of the metal rim 220 formed in the shape of a closed loop determines a resonant length at the first frequency f₁ in the first frequency band. The antenna pattern 210 formed to have a second length L2 smaller in one axial direction than the first length L1 may be configured to resonate in the second frequency band broader than the first frequency band. In this regard, a second loop length Lₚ₂ of the antenna pattern 210 formed in the shape of an open loop determines a resonant length at the second frequency f₂ in the second frequency band.

At least one ground terminal 152 on the PCB 150 may include a first ground terminal 152a and the second ground terminal 152b on the front surface of the PCB 150. The first ground terminal 152a and the second ground terminal 152b may be formed at a first point P1 and a second point P2, respectively, on the PCB 150. The first point P1 and the second point P2 are spaced apart in one axial direction from each other. At least one ground connection portion 221 of the metal rim 220 may include the first ground connection portion 221a and the second ground connection portion 221b. The first ground connection portion 221a and the second ground connection portion 221b may be formed at the first point P1 and the second point P2, respectively, on the internal surface of the metal rim 220. The first point P1 and the second point P2 are spaced apart in one axial direction from each other.

The first ground terminal 152a on the PCB 150 may be connected, at the first point P1, to the first ground connection portion 221a of the metal rim 220. The second ground terminal 152b on the PCB 150 may be connected, at the second point P2, to the second ground connection portion 221b of the metal rim 220.

The metal rim 220 may be formed in the shape of a closed loop. The first ground terminal 152a and the second ground terminal 152b on the PCB 150 may be formed on one side border region of the front surface of the PCB 150. The first ground connection portion 221a and the second ground connection portion 221b of the metal rim 220 may be formed on one side region of the metal rim 220. Accordingly, the first frequency band can be expanded up to a low frequency band by increasing the first loop length Lₚ₁ of the metal rim 220 connected to the first ground connection portion 221a and the second ground connection portion 221b. Therefore, the operational bandwidth of the antenna structure 200 that operates in the first frequency band and the second frequency band can be expanded.

The antenna pattern 210 may be formed, in the shape of an open loop, to have a first end portion and a second portion. The feeding terminal 151 on the PCB may be formed at a third point P3, on the front surface of the PCB 150. The third point P3 is spaced apart in the other axial direction toward the inside of the PCB 150 from the first point P1 The feeding terminal 151 on the PCB may be connected, at the third point P3, to the first end portion of the antenna pattern 210 in the shape of an open loop. Accordingly, the antenna pattern 210 is formed on the internal region of the metal rim 220, thereby decreasing the second loop length Lₚ₂ of the antenna pattern 210. Consequently, the second frequency band can be expanded up to a high frequency band. Therefore, the operational bandwidth of the antenna structure 200 that operates in the first frequency band and the second frequency band can be expanded.

The metal rims 220 in the antenna structures 200 and 200b may be formed in an optimal shape, taking into consideration the antenna characteristic and the shapes of both the dielectric housing 120 of the earbud and components within the electric housing 120. In this regard, the metal rim 220 may be configured to include a first loop 223a in the upper region and a second loop 223b in the lower region. The first loop 223a may be formed, in a first curved-line shape, in the upper region in a manner that is positioned in one axial direction above the first point P1. The first point P1 is a point to which the first ground terminal 152a on the PCB 150 is connected. The second loop 223b may be formed, in a second curved-line shape, in the lower region in a manner that is positioned in one axis direction below the first point P1.

The first loop 223a may be formed in such a manner that the maximum length Lmax 1 thereof in the other axial direction is greater than the maximum length Lmax2 in the other axial direction of the second loop 223b. Accordingly, the metal rim 220 is formed in the lower region where the antenna pattern 210 is arranged, in such a manner that the length thereof is smaller than the maximum length Lmax1. Consequently, the antenna efficiency can be increased by increasing coupling to the antenna pattern 210 arranged within the metal rim 220. The loop length of the metal rim 220 is increased in the upper region where the antenna pattern 210 is not arranged. Consequently, due to the metal rim 220, the second frequency band can be expanded up to a low frequency band. Accordingly, the operating bandwidths of the antenna structure 200 and 200b that operate in the first frequency band and the second frequency band can be expanded.

The antenna pattern 210 may be formed in the lower region where the antenna pattern 210 is arranged, in such a manner that the shape thereof corresponds to the shape of the metal rim 220. In this regard, the antenna pattern 210 may be formed, in a third curved-line shape, in one portion of the lower region. The antenna pattern 210 may be formed in one portion of the lower region, in such a manner that the third curved-line shape thereof corresponds to the second curved-line shape of the second loop 223b. Accordingly, a signal from the antenna pattern 210 is coupled, at or above the threshold level, to the metal rim 220. Consequently, the antenna efficiency can be increased.

The antenna pattern 210 is formed to have a plurality of sub-patterns. Consequently, the shape of each sub-pattern can be optimized. Accordingly, coupling between the antenna pattern 210 and the metal rim 220 in the first frequency band may be increased. Furthermore, only the antenna pattern 210 may operate, as a radiator, in the second frequency band. The antenna pattern 210 may be configured to include the first sub-pattern 211, the second sub-pattern 212, and the third sub-pattern 213.

One end portion of the first sub-pattern 211 may be connected to the feeding terminal 151 of the PCB 151. The first sub-pattern 211 may be formed to have a first straight-line length Ls1 in one axial direction. One end portion of the second sub-pattern 212 may be vertically connected to the other end portion of the first sub-pattern 211. The second sub-pattern 212 may be formed to have a second straight-line length Ls2 in the other axial direction. The first sub-pattern 211 and the second sub-pattern 212 are formed on the internal region of the metal rim 220. Consequently, the coupling between the antenna pattern 210 and the metal rim 210 can be reduced in the second frequency band. Accordingly, only the antenna pattern 210 may operate, as a radiator, in the second frequency band.

One end portion of the third sub-pattern 213 may be connected to the other end portion of the second sub-pattern 212. The third sub-pattern 213 may be formed to have a third curved-line length Lc3 in the third curved-line shape. In this regard, the third curved-line shape of the third sub-pattern 213 of the antenna pattern 210 may correspond to the second curved-line shape of the second loop 223b, which is the lower loop of the metal rim 220. The shape of the third sub-pattern 213 of the antenna pattern 210 corresponds to the shape of the second loop 223b of the metal rim 220. Consequently, the coupling between the antenna pattern 210 and the metal rim 210 can be increased in the first frequency band. Accordingly, the coupling between the antenna pattern 210 and the metal rim 220 is increased in the first frequency band. Consequently, the antenna efficiency can be increased. One end portion of the first sub-pattern 211 may correspond to the first end portion of the antenna pattern 210. In addition, the other end portion of the third sub-pattern 213 may correspond to the second portion of the antenna pattern 210.

The metal rim 220 as the antenna structure 200b is configured with a plurality of conductive patterns, and thus the antenna structure 200b may resonate in the first frequency band and the second frequency band. In this regard, the metal rim 220 may include the first sub-pattern 222a, a second sub-pattern 222b, and a loop pattern 223. The loop pattern 223 of the metal rim 220 may be configured to include the first loop 223a in the upper region and the second loop 223b in the lower region.

One end portion of the first sub-pattern 222a may be connected to the feeding terminal 151 and be formed to have a first pattern length Ls1 in one axial direction. One end portion of the second sub-pattern 222b may be connected to the other end portion of the first sub-pattern 222a and be formed to have a second pattern length Ls2 in the other axial direction. The loop pattern 223 may be connected to an end portion of at least one ground connection portion 221 and the other end portion of the second sub-pattern 222b and be formed in a closed loop. The first sub-pattern 222a and the second sub-pattern 222b may form the sub-pattern 222 of the metal rim 220.

The antenna structure 200b realized as the metal rim 220 may be configured to generate multi-resonance, similar to the antenna structure 200 realized as both the antenna pattern 210 and the metal rim 220. The loop pattern 223 of the metal rim 220 formed to have a first length L1b in one axial direction may be configured to resonate in the first frequency band. The region is formed to have a second length L2b smaller than the first length L1b in one axial direction may be configured to resonate in the second frequency band broader than the first frequency band. The sub-pattern 222 of the metal rim 220 and at least one region of a loop pattern 223b connected to the sub-pattern 222 are formed to have the second length L2b and are configured to resonate in the second frequency band.

At least one ground terminal 152 of the metal rim 220 as the antenna structure 200b may include the first ground terminal 152a and the second ground terminal 152b, formed at the first point P1 and the second point P2, respectively, on the front surface of the PCB 150. The first point P1 and the second point P2 are spaced apart from each other in one axial direction. At least one ground connection portion 221 may include the first ground connection portion 221a and the second ground connection portion 221b, formed at the first point P1 and the second point P2, respectively, on one lateral surface of the metal rim 220. The first point P1 and the second point P2 are spaced apart from each other in one axial direction. The first ground terminal 152a may be connected, at the first point P1, to the first ground connection portion 221a. The second ground terminal 152b may be connected, at the second point P2, to the second ground connection portion 221b.

The metal rim 220 as the antenna structure 200b may also be formed in a closed-loop shape, similar to the metal rim 220 in the antenna structure 200 realized as the antenna pattern 210 and the metal rim 220. The first ground terminal 152a and the second ground terminal 152b may be formed on one side border region of the front surface of the PCB 150. The first ground connection portion 221a and the second ground connection portion 221b of the metal rim 220 may be formed on one side region of the metal rim 220 in the shape of a closed loop. Accordingly, the first frequency band can be expanded up to a low frequency band by increasing the first loop length Lp1 of the metal rim 220 connected to the first ground connection portion 221a and the second ground connection portion 221b. Therefore, the operational bandwidth of the antenna structure 200b that operates in the first frequency band and the second frequency band may be expanded.

The metal rim 220 as the antenna structure 200b may be formed in an optimal shape, taking into consideration the antenna characteristic and the shapes of both the dielectric housing 120 of the earbud and components within the electric housing 120. In this regard, the metal rim 220 may be configured to include the first loop 223a in the upper region and the second loop 223b in the lower region. The first loop 223a may be formed, in the first curved-line shape, in the upper region in a manner that is positioned in one axial direction above the first point P1. The first point P1 is a point to which the ground terminal 152a on the PCB 150 is connected. The second loop 223b may be formed, in the second curved-line shape, in the lower region in a manner that is positioned in one axis direction below the first point P1.

In the antenna structure 200b, the first loop 223a may also be formed in such a manner that the maximum length Lmax1 thereof in the other axial direction is greater than the maximum length Lmax2 in the other axial direction of the second loop 223b. Accordingly, the metal rim 220 is formed in the lower region in such a manner that the length thereof is smaller than the maximum length Lmax1. Consequently, the first frequency band can be expanded up to the high frequency band by decreasing the size of the sub-pattern 222 formed within the metal rim 220. The loop length of the metal rim 220 is increased in the upper region where the antenna pattern 210 is not formed. Consequently, due to the metal rim 220, the second frequency band can be expanded up to a low frequency band. Accordingly, the operating bandwidths of the antenna structures 200 and 200b that operate in the first frequency band and the second frequency band can be expanded.

The antenna pattern 210 may be formed in the lower region where the antenna pattern 210 is arranged, in such a manner that the shape thereof corresponds to the shape of the metal rim 220. In this regard, the antenna pattern 210 may be formed, in a third curved-line shape, in one portion of the lower region. The antenna pattern 210 may be formed in one portion of the lower region, in such a manner that the third curved-line shape thereof corresponds to the second curved-line shape of the second loop 223b. Accordingly, a signal from the antenna pattern 210 is coupled, at or above the threshold level, to the metal rim 220. Consequently, the antenna efficiency can be increased.

Therefore, the structural and technical characteristics of the earbud according to the present disclosure are summarized as follows. The proposed antenna structure 200 may be configured with the antenna pattern 210, the metal rim 220, the feeding terminal 152, and the ground terminals 152a and 152b. The proposed antenna structure 200b may be configured with the metal rim 220, the feeding terminal 152, and the ground terminals 152a and 152b.

The use of the entire metal loop structure of the metal rim 220 exposed to the outside makes it possible to obtain a broader bandwidth and a higher efficiency than the use of the existing 2/4 antenna. In the existing structure, an antenna is realized in one region of the earbud by using an antenna element with the 2/4 length. However, in the proposed antenna structures 200 and 200b, the entire length of the metal rim 220 exposed to the outside is used for an antenna element. For this reason, it is possible to improve the antenna bandwidth and efficiency resulting from an increase in antenna volume. In addition, since ground coupling is minimized by using the metal rim 220 exposed to the outside as an antenna, it is possible to expand the bandwidth and to improve the antenna efficiency.

A multi-band structure, in which a slit and a stub line are used in a manner suitable for the length of each frequency band to adjust a resonance frequency, may be designed for a mobile terminal employing the metal rim structure. However, because the earbud features a compact internal space, there is a structural limitation on realizing the multi-band structure by adding a slit and a stub line for each frequency band. In addition, because it is difficult to connect the stub line to the metal rim 220, it is not easy to adjust the resonance frequency. However, according to the present disclosure, the resonance frequency may be adjusted by applying the ground terminal 152a to the metal rim 220.

Because the radiator is exposed to the outside, the grounding coupling is minimized. Consequently, it is possible to expand the bandwidth and to improve the antenna efficiency. The issue of low resonance frequency occurring when the entire region of the metal rim 220 is used can be addressed using the position of the ground terminal 152a and a matching element MC1. The issue of antenna impedance matching can be addressed using a matching element MC2 connected to the ground terminal 152b.

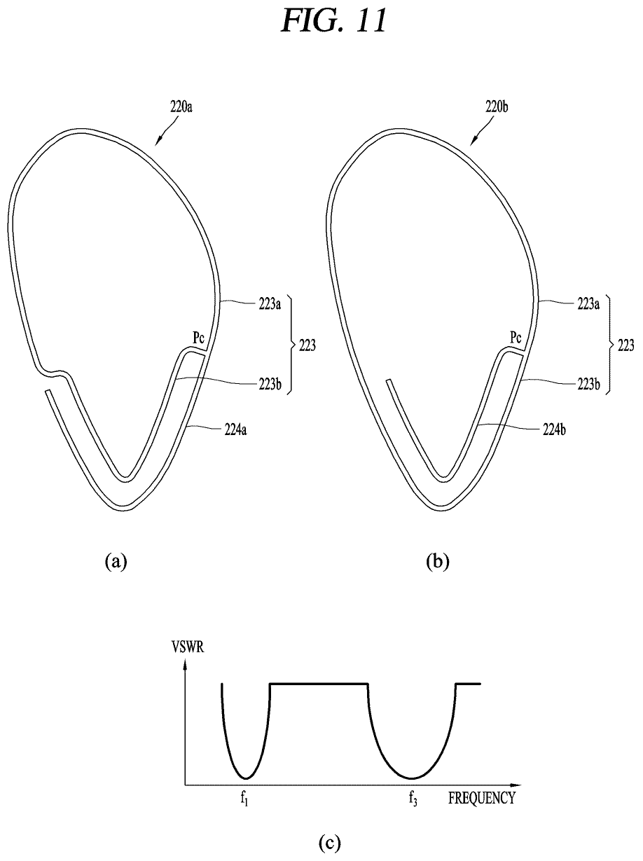

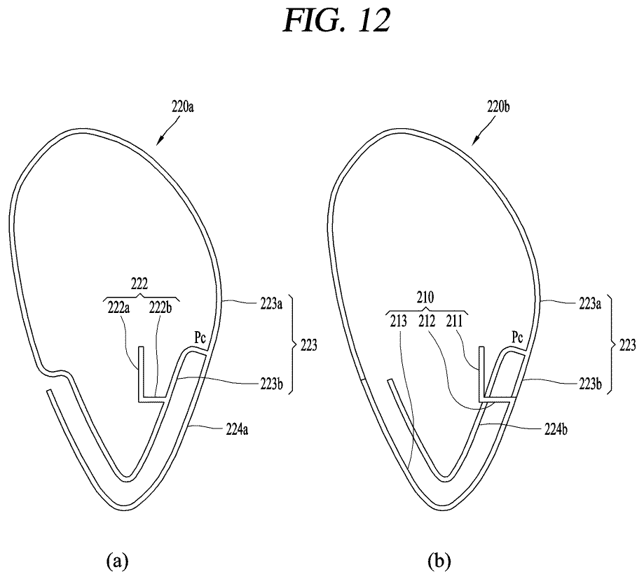

The shapes of the metal rims 220 in the antenna structures 200 and 200b according to the present disclosure may be designed optimally for operation in a broadband frequency band. In this regard, FIG. 11 is a set including views and a graph that illustrate antenna structures formed with metal rims and connection patterns, and the VSWR characteristics of the antenna structures. FIG. 12 is a set of views that illustrate different antenna structures formed by the metal rims in FIG. 11.

(a) of FIG. 11 illustrates a metal rim 220a provided with a connection pattern 224a. The connection pattern 224a is arranged outward from the metal rim 220a in a manner that is spaced apart from the metal rim 220a. The second loop 223b, which is the lower loop of the metal rim 220a, is arranged more inward in an offset manner at a connection point Pc than the first loop 223a, which is the upper loop of the metal rim 220a. (b) of FIG. 11 illustrates the metal rim 220a provided with a connection pattern 224b. The connection pattern 224b is arranged inward from a metal rim 220b in a manner that is spaced apart from a metal rim 220b. The connection patterns 224a and 224b may be arranged on the same plane as the dielectric housing on which the metal rims 220a and 220b is arranged. As another example, the connection patterns 224a and 224b may be arranged on a different plane than the dielectric housing on which the metal rims 220a and 220b is arranged. In this regard, the connection patterns 224a and 224b may be formed as an FPCB and be formed within the dielectric housing.

With reference to (a) to (c) of FIG. 11, the antenna structure is configured to generate multi-resonance due to the connection patterns 224a and 224b of the metal rim 220a. The antenna structure may be configured to resonate in the first frequency band including the first frequency f₁ and a third frequency band including a third frequency f₃, due to the connection patterns 224a and 224b of the metal rim 220a. The third frequency f₃ in (c) of FIG. 11 may be a frequency higher than the second frequency f₂ in FIG. 10. In this regard, the first frequency band and the second frequency band may be 2.3 GHz and 2.6 GHz bands, respectively, which are Bluetooth (BT)/Wi-FI frequency bands, but are not limited thereto. The first frequency band and the second frequency band may each be variable according to the application. The third frequency band, including the third frequency f₃, may be a 5 GHz band or a 7 GHz or higher UWB communication band, but is not limited thereto. The third frequency band may be variable according to the application.

With reference to FIGS. 7 and 11, the metal rim 220a and 220b as the antenna structure 200b may include the first loop 223a and the second loop 223b. The metal rims 220a and 220b as the antenna structure 200b may further include the connection patterns 224a and 224b, respectively. The first loop 223a may be formed in the first curved-line shape in the upper region in a manner that is positioned in one axial direction above the first point P1 to which the ground terminal 152a is connected. The second loop 223b may be formed in the second curved-line shape in a manner that is positioned in one axial direction below the first point P1.

The connection patterns 224a and 224b may be connected to the connection point Pc that is one point on the metal rim 220. The connection patterns 224a and 224b may be arranged inward and outward, respectively, from the second loop 223b, in a manner that is spaced apart from the second loop 223b. The metal rim 220 may radiate a signal in the first frequency band due to the first loop 223a and the second loop 223b. The connection patterns 224a and 224b of the metal rim 220 may radiate a signal in the third frequency band broader than the first frequency band.

Each of the metal rim 220a in (a) of FIG. 11 and the metal rim 220b in (b) of FIG. 11 may be formed as the antenna structure 200 in FIG. 6 or the second antenna structure 200b in FIG. 7. In this regard, FIG. 12 illustrates an antenna structure according to an embodiment, in which the metal rim connected to the connection pattern is connected to the sub-pattern and an antenna structure according to an embodiment, which is coupled to the antenna pattern.

With reference to (a) of FIG. 12, the metal rim 220a may include the sub-pattern 222 connected to the second loop 223b in the lower region. The sub-pattern 222 may include the first sub-pattern 222a and the second sub-pattern 222b perpendicular to the first sub-pattern 222a. The second sub-pattern 222b may be connected to the second loop 223b in the lower region. The antenna structure in (a) of FIG. 12 may correspond to a structure that results from adding the connection pattern 224a to the second antenna structure 200b in FIG. 7. Due to the loop pattern 223, the antenna structure may transmit and receive a signal in the first frequency band. Due to the sub-pattern 222 and one portion of the second loop 223b in the lower region, the antenna structure may transmit and receive a signal in the second frequency band broader than the first frequency band. Due to the connection pattern 224a, the antenna structure may transmit and receive a signal in the third frequency band broader than the second frequency band.

With reference to (b) of FIG. 12, the metal rim 220b may include the first sub-pattern 211, the second sub-pattern 212, and the third sub-pattern 213 that are configured to be spaced predetermined distances apart from each other below the second loop 223b and to couple a signal to the metal rim 220b. The antenna pattern 210 may include the first sub-pattern 211, the second sub-pattern 212 perpendicular to the first sub-pattern 211, and the third sub-pattern 213 in the shape of a loop. The third sub-pattern 213 may be formed in a shape corresponding to the second loop 223b in the lower region. The antenna structure in (b) of FIG. 12 corresponds to a structure that results from adding the connection pattern 224b to the second antenna structure 200 in FIG. 6. Due to the loop pattern 223, the antenna structure may transmit and receive a signal in the first frequency band. Due to the antenna pattern 210, the antenna structure may transmit and receive a signal in the second frequency band broader than the first frequency band. Due to the connection pattern 224a, the antenna structure may transmit and receive a signal in the third frequency band broader than the second frequency band.

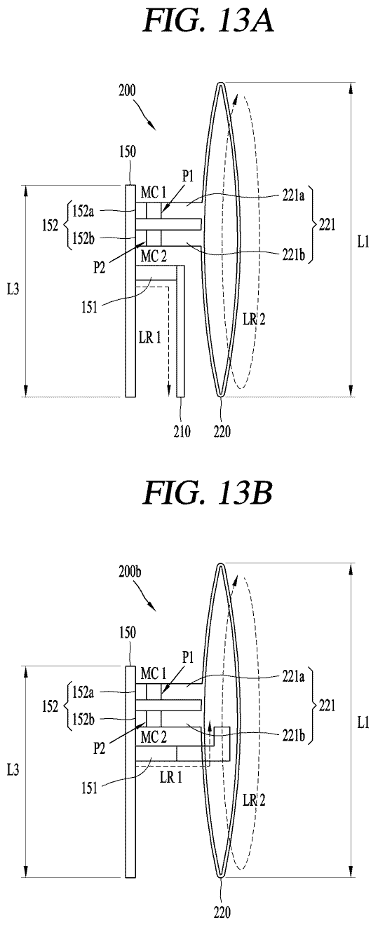

The structure arranged within the earbud according to the present disclosure can improve the antenna matching characteristic through an impedance matching circuit. In this regard, FIGS. 13A and 13B are views, each illustrating a structure in which the structure is connected to the ground terminals on the PCB through the impedance matching element. The antenna structure 200 in FIG. 13A may be configured to include the antenna pattern 210 and the metal rim 220. The antenna structure 200b in FIG. 13B may be formed as a single structure of the metal rim 220.

With reference to FIGS. 13A and 13B, at least one ground connection portion 221 of the metal rim 220 may be connected to at least one ground terminal 152 on the PCB 150 through the impedance matching elements MC1 and MC2. Specifically, the first ground terminal 152a on the PCB 150 may be connected, at the first point P1, to the first ground connection portion 221a of the metal rim 220 through the first match matching element MC1. The second ground terminal 152b on the PCB 150 may be connected, at the second point P2, to the second ground connection portion 221b of the metal rim 220 through the second matching element MC2.

The first matching element MC1 connected to the first ground connection portion 221a may be a connection pattern with an impedance of 0 ohm. In this regard, according to the application, the first matching element MC1 may also be realized as an inductor with an inductance of 2 nH or less or as a capacitor with a capacitance of 7 pF or more. The second matching element MC2 connected to the second ground connection portion 221b may be realized as an inductor. The second matching element MC2 may be formed as an inductor with an inductance of 1 nH to 5 nH.

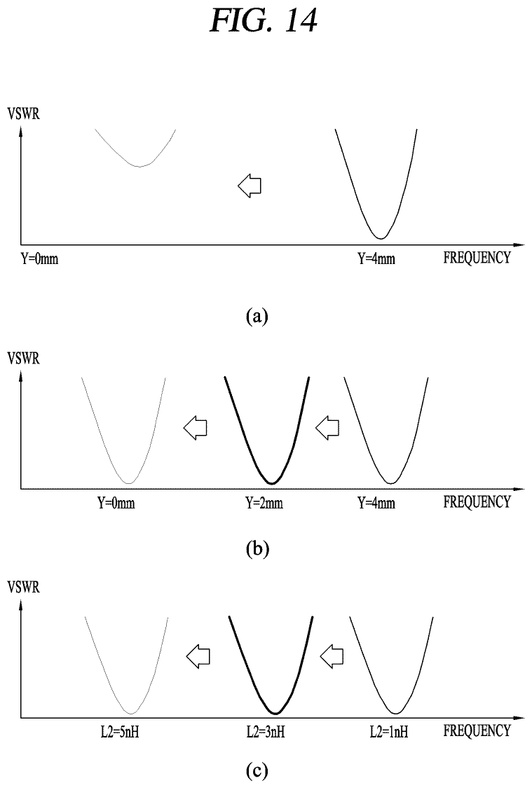

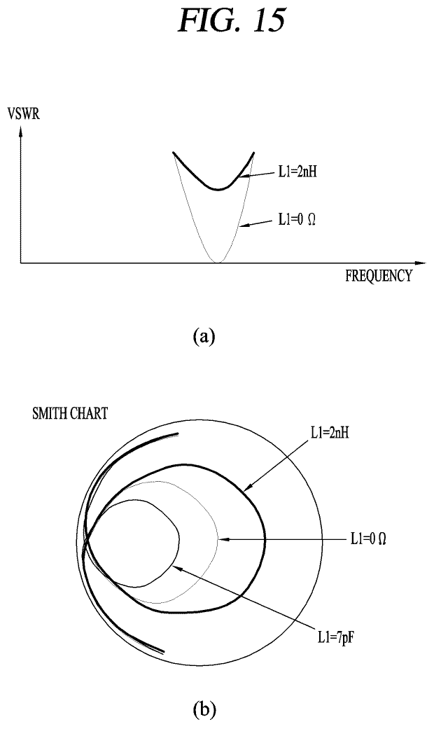

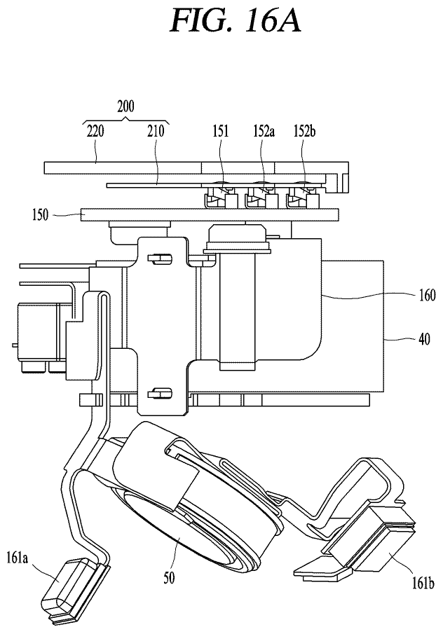

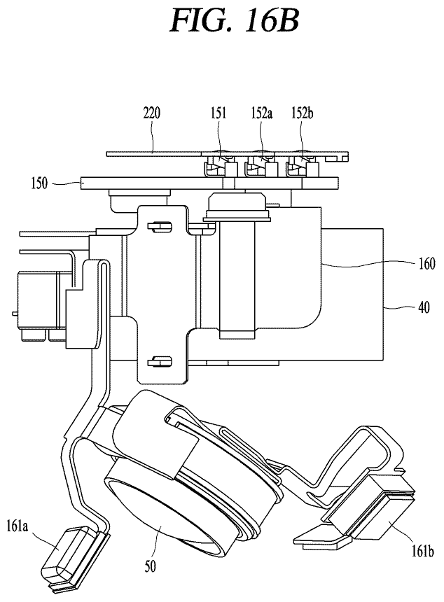

As described above, the antenna performance may be adjusted by adjusting a value of the matching element or adjusting the distance to the ground connection portion in the antenna structure arranged within the earbud according to the present disclosure. In this regard, FIG. 14 is a set of graphs that illustrate the VSWR characteristic which varies with the distance between the antenna structure and the ground connection potion, and the VSWR characteristic which varies with the inductance value of the second matching element. FIG. 15 is a set including a graph and a view that illustrate the VSWR characteristic and impedance characteristic of the antenna structure that vary with a type of the first matching element.

(a) of FIG. 14 illustrates the VSWR characteristic of the loop antenna 200a in (a) of FIG. 10. With reference to (a) of FIG. 10 and (a) of FIG. 14, the distance between the feeding terminal 151 on the PCB and the ground terminal 152 may be expressed as Y. As the distance Y between the feeding terminal 151 and the ground terminal 152 decreases, the impedance matching characteristics decrease, thereby decreasing the VSWR characteristic to a threshold value or beyond.

(b) of FIG. 14 illustrates the VSWR characteristics of the antenna structure 200 in FIGS. 6 and 13A and the second antenna structure 200b in FIGS. 7 and 13B. These VSWR characteristics vary with the distance between the ground terminals. With reference to FIGS. 13A and 13B, and (b) of FIG. 14, the distance Y between the first and second ground terminals 152a and 152b may be expressed as Y. As the distance Y between the first and second ground terminals 152a and 152b decreases, the impedance matching characteristic does not decrease.

The resonance frequencies of the antenna structures 200 and 200b may be adjusted by adjusting the distance Y between the first and second ground terminals 152a and 152b to a range from 0 mm to 4 mm. In the antenna structures 200 and 200b, the first ground connection portion 221a and the second ground connection portion 221b of the metal rim 220 may be formed in such a manner that the distance between thereof ranges from 0 mm to 4 mm in one axial direction. A structure in which the distance between the first ground connection portion 221a and the second ground connection portion 221b is 0 mm is a structure in which one ground connection portion 221 is connected to one ground terminal 152. As the distance to the second ground connection portion 221b increases, the resonance frequencies (or the first frequencies in the first frequency band) of the antenna structures 200 and 200b may increase.

(c) of FIG. 14 illustrates the VSWR characteristic of the antenna structure 200 in FIGS. 6 and 13A and the VSWR characteristic of the second antenna structure 200b in FIGS. 7 and 13B. These VSWR characteristics vary with the inductance values of the second matching element. With reference to FIGS. 13A and 13B and (c) of FIG. 14, the resonance frequency may be adjusted to be in a low frequency band by adjusting the inductance value of the second matching element MC to a range from 1 nH to 5 nH.

(a) of FIG. 15 illustrates the VSWR characteristic of the antenna structure 200 in FIGS. 6 and 13A and the VSWR characteristic of the antenna structure 200b in FIGS. 7 and 13B. These VSWR characteristics vary with an inductance or capacitance value of the first matching element. (b) of FIG. 15 illustrates the impedance characteristic of the antenna structure 200 in FIGS. 6 and 13A and the impedance characteristic of the second antenna structure 200b in FIGS. 7 and 13B. These impedance characteristics vary with the inductance or capacitance value of the first matching element.

With reference to FIGS. 13A and 13B and (a) of FIG. 15, the structure in which the first matching element MC1 is realized as a connection pattern with an impedance of 0 ohm has the lowest VSWR value. The structure in which in the first matching element MC1 is realized as an inductor with an inductance of 2 nH has a poorer impedance matching characteristic than the structure that is realized as a connection pattern with an impedance of 0 ohm. Consequently, the VSWR value increases. With reference to FIGS. 13A and 13B and (b) of FIG. 15, the structure in which the first matching element MC1 is realized as a connection pattern with an impedance of 0 ohm has a matched impedance of 50 ohm, thereby having the highest antenna efficiency. The structure in which the first matching element MC1 is realized as an inductor with an inductance of 2 nH has an impedance of less than 50 ohm. Consequently, the VSWR and the antenna efficiency are decreased. The structure in which the first matching element MC1 is realized as a capacitor with a capacitance of 7 pF has an impedance of more than 50 ohm. Consequently, the VSWR and the antenna efficiency are decreased.

Therefore, the first ground terminal 152a on the PCB 150 may be directly connected to the first ground connection portion 221a or be connected, at the first point P1, to the first ground connection portion 221a through the first matching element MC1. The second ground terminal 152b on the PCB 150 may be connected, at the second point P2, to the second ground connection portion 221b through the second matching element MC2. The first matching element MC1 connected to the first ground connection portion 221a may be a connection pattern with an impedance of 0 ohm. The second matching element MC2 connected to the second ground connection portion 221b may be formed as an inductor with an inductance of 1 nH to 5 nH. As the inductance of the second matching element MC2 increases, the resonance frequency (or the first frequency in the first frequency band) of the antenna structure 200 may be decreased.

The metal rim 220 in the antenna structure 200b arranged within the earbud according to the present disclosure may be formed in such a manner as to have a larger size than the antenna pattern 210 and the PCB 150. Consequently, the resonance frequency, in the first frequency band, of the antenna structure 200 may be expanded to a low frequency band. Accordingly, the operational bandwidth of the antenna structure 200 that operates in the first frequency band and the second frequency band may be expanded.

With reference to FIGS. 13A and 13B, the PCB 150 may be formed to have a third length L3 in one axial direction. The metal rim 220 formed in the shape of a closed loop may be formed to have the first length L1 greater than the third length L3 in one axial direction. The lower end portion, in one axial direction, of the metal rim 220 may be formed in such a manner that a first low-end point Lp1 thereon overlaps a second low-end point Lp2 on the lower end portion, in one axial direction, of the PCB 150.

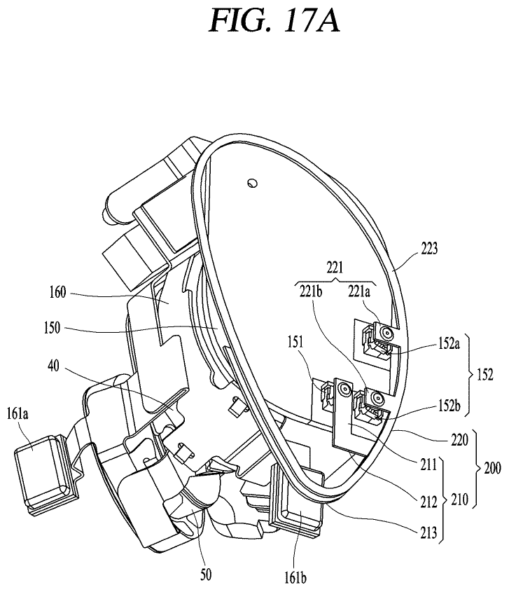

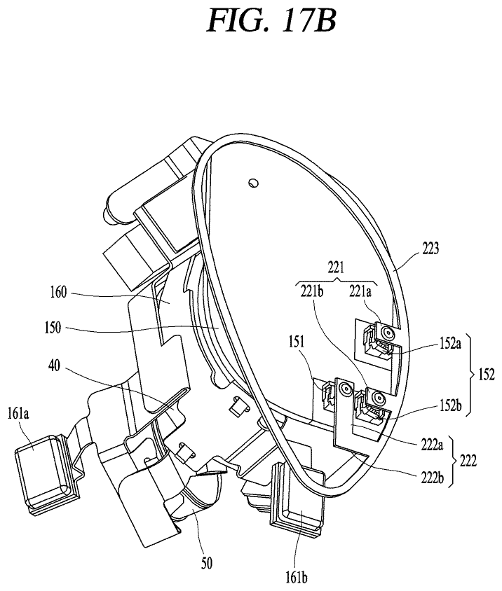

Electronic components and a coupling structure may be arranged within the dielectric housing 120 of the earbud 100 equipped with the antenna structure according to the present disclosure. In this regard, FIG. 16A is a view illustrating other electronic components and a coupling structure that are arranged within the earbud equipped with the antenna structure in FIG. 6, and FIG. 16B is a view illustrating other electronic components and a coupling structure that are arranged within the earbud equipped with the antenna structure in FIG. 7. FIG. 17A is a perspective view illustrating the earbud equipped with the antenna structure in FIG. 16A. FIG. 17B is a perspective view illustrating the earbud equipped with the antenna structure in FIG. 16B.

With reference to FIGS. 6, 16A, and 17A, the antenna structure 200 may be configured to include the antenna pattern 210 and the metal rim 220. The metal rim 220 may include the ground connection pattern 221 and the loop pattern 223 in the shape of a loop. With reference to FIGS. 7, 16B, and 17B, the antenna structure 200b is realized as the metal rim 220. The metal rim 220 may include the ground connection pattern 221, the sub-pattern 222, and the loop pattern 223 in the shape of closed loop. The sub-pattern 222 may include the first sub-pattern 222a and the second sub-pattern 222b perpendicular to the first sub-pattern 222a.

With reference to FIGS. 6, 7, 16A, and 16B, the earbud 100 may include the battery 40 and the speaker 50. The earbud 100 may include the flexible printed circuit board 160. In this regard, other electronic components, that is, the battery 40 and the speaker 50, as well as the antenna structure 200 may be arranged in the accommodation space in the dielectric housing 120 of the earbud 100. In addition, the coupling structure, that is, the FPCB 160 may be arranged in the accommodation space in the dielectric housing 120 of the earbud 100.

The battery 40 may be arranged on the rear surface of the PCB 150. The battery 40 may be configured to supply electric power to electric components within the earbud 100. The speaker 50 may be arranged behind the rear surface of the PCB 150 in the accommodation space in the dielectric housing 120. The speaker 50 may be configured to reproduce voice content received from a paired electronic device. The FPCB 160 may be connected to the PCB 150 through the rear surface of the PCB 150. The FPCB 160 may be formed in such a manner as to surround the battery 40 and the speaker 50 and be configured to control the battery 40 and the speaker 50. Accordingly, a control circuit on the PCB 150 may transfer control signals to electronic components arranged on the FPCB 160 or coupled to the FPCB 160, thereby controlling the operations of the electronic components.

The FPCB 160 may include the first accommodation space and the second accommodation space inside that are capable of accommodating electronic components. A first microphone 161a and a second microphone 161b may be arranged in the first accommodation space and the second accommodation space, respectively. The control circuit on the PCB 150 may convert a voice signal, received through at least one of the first and second microphones 161a and 162b, into a wireless signal. The control circuit on the PCB 150 may perform control in such a manner that the wireless signal, resulting from the conversion, is radiated through the feeding terminal 151 and through the antenna structure 200 including the antenna pattern 210 and the metal rim 220. Accordingly, the control circuit on the PCB 150 may enable the wireless signal, resulting from the conversion, to be transferred to the paired electronic device through the antenna structure 200.

The antenna structure provided within the earbud according to the present disclosure, and the earbud equipped with the antenna structure are described above. The antenna structure provided within the earbud according to the present disclosure, and an electronic device equipped with the antenna structure are described below with reference to the structural and technical characteristics described above. In this regard, the earbud may be referred to as an electronic device. The earbud receives content, such as music, through wireless communication with a mobile terminal (a host device). Therefore, the wireless earbud may be configured as a wireless earbud. The structural and technical characteristics may apply to the electronic device described below. In addition, the configuration of the antenna structure (the antenna module) and the technique of the wireless connection through the electronic device equipped with the antenna structure may also apply to the earbud.

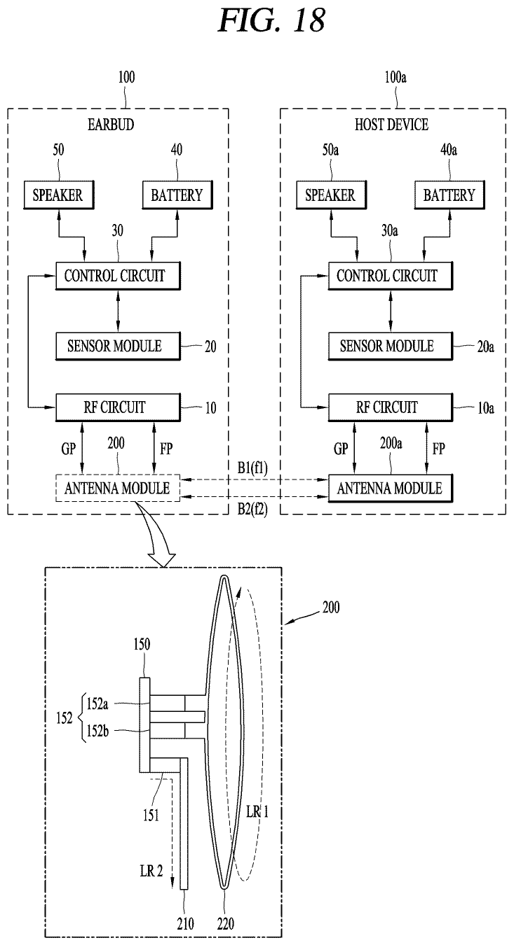

In this regard, as described above, FIG. 18 illustrates the configuration of the electronic device equipped with the antenna module and the configuration of the antenna module. An electronic device 100 may include the antenna module 200 and may further include the RF circuit 10 and the processor 30. With reference to FIGS. 1 to 15, the electronic device 100 equipped with the antenna structure is described. In this regard, the electronic device 100, such as the wireless earbud, may include the antenna module 200 in FIGS. 1 and 18 and the dielectric housing 120 in FIG. 2.

With reference to FIGS. 1 to 15, the wireless device 100, such as the wireless earbud, may further include the RF circuit 10, the sensor module 20, the control circuit 30, the battery 40 (or a battery 240), and the microphone 50 (or a microphone 250). A memory may be included in the control circuit 30 and also be provided separately therefrom. In a case where the electronic device 100, such as the wireless earbud, includes a memory, the electronic device 100 may receive a wireless signal from a host device 100a through a Wi-Fi wireless interface in addition to a UWB wireless interface. The memory may be configured to store received content, control information, or setting information.

With reference to FIGS. 1 to 18, the electronic device 100 equipped with the antenna module 200 is described. The electronic device 100 may be configured to include the dielectric housing 120 and the antenna module 200. The dielectric housing 120 may be configured to include the main body portion 120b, having a portion, and the protruding portion 122, extending from the main body portion 120b. The antenna module 200 in FIG. 18 is not limited to the antenna structure 200 in (c) of FIG. 8, and may be realized as the second antenna structure 200b in (d) of FIG. 8, which is realized as the metal rim 220.

With reference to FIGS. 1 to 18, the antenna module 200 of the electronic device 100, which is realized as the wireless earbud, may include the antenna pattern 210 arranged on the inward-facing portion of the internal surface 122 of the dielectric housing 120. The antenna module 200 may include the metal rim 220 that is formed on the outward-facing portion of the external surface 121 of the dielectric housing 120, with at least one ground connection portion 152 of the PCB 150 being formed on the internal surface of the metal rim 220. The antenna pattern 210 may be connected to the feeding terminal 151 on the PCB. At least one ground connection portion 152 of the metal rim 220 may be connected to at least one ground connection portion 152 of the PCB 150. A signal applied to the antenna pattern 210 through the feeding terminal 151 on the PCB may be radiated through the antenna structure 200 including the antenna pattern 210 and the metal rim 220.

With reference to FIGS. 1 to 18, the antenna module 200 of the electronic device 100 that is realized as the wireless earbud may include the metal rim 220 formed on the inward-facing portion 122a of the internal surface 122 or the outward-facing portion 121a of the external surface 121. The metal rim 220 may be connected to the feeding terminal 151 and at least one ground connection portion 152 of the PCB 150. At least one ground connection portion 152 of the metal rim 220 may be connected to at least one ground connection portion 152 of the PCB 150. A signal applied to the metal rim 220 through the feeding terminal 151 of the PCB 150 may be radiated through the second antenna structure 200b as the metal rim 220.

The electronic device 100 may receive a wireless signal from the host device 100a through different wireless interfaces, thereby improving content reproduction capability. In this regard, as described above, FIG. 14 illustrates the configuration of the electronic device equipped with the antenna module according to the present disclosure and the configuration of the antenna module. The electronic device 100 may include the antenna module 200 and may further include the RF circuit 10 and the processor 30.

The RF circuit 10 is operatively coupled to the antenna module 200 and may be configured to transfer a wireless signal in a specific frequency band to the antenna module 200. The processor 30 is operatively coupled to the RF circuit 10 and may be configured to control the RF circuit 10.

The processor 30 may control the RF circuit 10 in such a manner that a first wireless signal in a first frequency band B1 is received through the antenna module 200. When the signal quality of the first wireless signal is at or below a threshold value, a wireless signal may be received through a different frequency band, thereby always ensuring stable reception of content contained in the wireless signal. To this end, it may be determined by the processor 30 or a processor of the host device 100a whether or not the signal quality of the first wireless signal is at or below the threshold value.

When the signal quality of the first wireless signal is at or below the threshold value, the host device 100a may content, such as music, to the electronic device 100, such as the wireless earbud, through a second wireless signal in a first frequency band. The signal quality of a wireless signal may be determined by determining whether or not an SNR or SINR of the wireless signal is at or above a threshold value, but is not limited to this determination.

Through the sensor module 20, the signal quality of the wireless may also be estimated based on whether or not the user moves or on the user's moving speed and/or acceleration. The quality of the wireless signal may be estimated by determining whether or not the user enters a specific region determined as a region where other users stay during a specific time span or by a distance to the specific region. The quality of the wireless signal may be estimated by a value, which results from sensing through the sensor module 20 described above, and may be estimated by determining whether or not the user enters a specific region or by a distance to the specific region. In this regard, the first wireless signal may be a Bluetooth signal in the 2.4 GHz band or a Wi-Fi signal, but is not limited to these signals. The second wireless signal may be a UWB signal in the 5 GHz band or a Wi-Fi signal, but is not limited to these signals.

As another example, in the case of real-time content, the host device 100a may simultaneously transmit the same content through the first wireless signal and the second wireless signal to the electronic device 100. According to the signal quality, the processor 30 may also receive the first wireless signal and the second wireless signal selectively or simultaneously.

When it is determined that the signal quality of the first wireless signal is at or below the threshold value, the processor 30 may control the RF circuit 10 in such a manner that the second wireless signal in a second frequency band B2 broader than the first frequency band B1 is received from the host device 100a through the antenna module 200. The first wireless signal may be a wireless signal at the first frequency f₁ in the first frequency band B1, that is, the 2.4 GHz band. The second wireless signal may be a wireless signal at the second frequency f₂ in the second frequency band B2, that is, the 5 GHz band or the 7 GHz UWB band. Therefore, the electronic device 100 can improve content reproduction capability by receiving a wireless signal through different wireless interfaces from the host device 100a.

The configuration of the wireless earbud equipped with the antenna structure is described in detail above. The technical effects of the wireless earbud equipped with this antenna structure described above are summarized as follows, but are not limited to these technical effects.

The technical effects of the wireless earbud equipped with the antenna structure are described as follows.

According to the present disclosure, the antenna structure with a reduced antenna space can be arranged within the housing of the wireless earbud. Consequently, a wireless signal containing content can be received.

According to the present disclosure, the antenna structure is enabled to operate in a plurality of frequency bands in the electronic device, such as the wireless earbud, thereby ensuring stable reception of a wireless signal even in changing environmental conditions.

According to the present disclosure, the ground coupling is minimized using a separate metal rim structure as an antenna. Consequently, it is possible to expand the bandwidth and to improve the antenna efficiency.

According to the present disclosure, the antenna volume increases using the entire metal rim as a radiator. Consequently, it is possible to expand the bandwidth and to improve the antenna efficiency.

According to the present disclosure, through the use of the structure that includes a plurality of conductive patterns, it is possible for the antenna structure to perform multi-resonance.

According to the present disclosure, the effective volume of the antenna is increased by forming an external radiation structure in the shape of a metal rim in such a manner as to surround the antenna pattern. Consequently, the bandwidth characteristic of the antenna can be improved.

According to the present disclosure, the effective volume of the antenna is increased by forming the external radiation structure in the shape of a metal rim in such a manner as to surround the antenna pattern. Consequently, the efficiency characteristic of the antenna can be improved.

According to the present disclosure, the effective volume of the antenna is increased by forming the sub-pattern on a radiation structure in the shape of a metal rim. Consequently, the bandwidth characteristic of the antenna can be improved.

According to the present disclosure, the effective volume of the antenna is increased by forming the sub-pattern on the radiation structure in the shape of a metal rim. Consequently, the efficiency characteristic of the antenna can be improved.

According to the present disclosure, the resonance frequency and the impedance matching can be adjusted independently by employing a plurality of ground terminals.

According to the present disclosure, a welding process for metal rim contact is not required. Consequently, an assembly process can be simplified.

According to the present disclosure, the antenna structure can be configured to operate in a broadband frequency band in an electronic device, such as the wireless earbud.

While the wireless earbud is worn on a user's ear, the antenna resonance frequency may change due to the user's movement and the wireless earbud's movement within the cavity in the user's ear. According to the present disclosure, a wireless signal can be stably received even under such conditions.

According to the present disclosure, a change in antenna performance, which is caused by a small antenna arrangement space arranged within the mechanism of the wireless earbud, can be minimized. Consequently, wireless communication performance can be stably maintained.

An additional scope of applicability of the present disclosure would be apparent from the description detailed below. However, various modifications and alterations to the present disclosure within the scope of its technical idea would be clearly understandable to a person of ordinary skill in the art. Therefore, it should be noted that the detailed description and specific embodiments, such as preferred embodiments of the present disclosure, are provided in an exemplary manner.

An additional scope of applicability of the present disclosure would be apparent from the description detailed below. However, various modifications and alterations to the present disclosure within the scope of its technical idea would be clearly understandable to a person of ordinary skill in the art. Therefore, it should be noted that the detailed description and specific embodiments, such as preferred embodiments of the present disclosure, are provided in an exemplary manner.

The antenna structure arranged in the above-mentioned antenna structure according to the present disclosure and the operation of controlling the antenna structure may be realized in software, firmware, or a combination of both. The antenna structure arranged in the wireless earbud and the configuration for performing the operation of controlling the antenna structure is possibly realized as computer-readable codes on a program-recorded medium. Computer-readable mediums include all types of recording devices on which data readable by a computer system are stored. Examples of the computer-readable medium include a hard disk drive (HDD), a solid-state disk (SSD), a silicon disk drive (SDD), a ROM, a RAM, a CD-ROM, a magnetic tape, a floppy disk, an optical data storage device, and the like. The computer-readable medium may also be realized in the form of a carrier wave (such as for transmission over the Internet). In addition, the computer may also include a control unit, that is, a processor, for a terminal or a wireless earbud. Therefore, the description detailed above should be considered as being exemplary without being interpreted in a limited manner in all aspects. The scope of the present disclosure should be determined by proper construction of the following claims. All equivalent modifications to the embodiments of the present disclosure fall within the scope of the present disclosure.

1-20. (canceled)

21. An earbud comprising:
a dielectric housing having an internal surface that defines an accommodation space, and an external surface that surrounds the internal surface;
a printed circuit board (PCB) arranged in the accommodation space in the dielectric housing and including a feeding terminal and at least one ground terminal;
an antenna pattern arranged on the inward-facing portion of the internal surface of the dielectric housing; and
a metal rim formed on the outward-facing portion of the external surface of the dielectric housing, at least one ground connection portion of the metal rim being formed on the internal surface of the metal rim,
wherein the antenna pattern is connected to the feeding terminal on the PCB,
wherein the at least one ground connection portion of the metal rim is connected to the at least one ground terminal on the PCB, and
wherein a signal applied to the antenna pattern through the feeding terminal is radiated through an antenna structure including the antenna pattern and the metal rim,
wherein the at least one ground terminal includes a first ground terminal and a second ground terminal that are formed at a first point and a second point, respectively, on the front surface of the PCB, the first point and the second point being spaced apart in one axial direction from each other,
wherein the metal rim comprises:
a first loop formed, in a first curved-line shape, in an upper region in a manner that is positioned in the one axial direction above the first point to which the first ground terminal is connected; and
a second loop formed, in a second curved shape, in a lower region in a manner that is positioned in the one axial direction below the first point,
wherein the first loop is formed in such a manner that the maximum length thereof in the other axial direction is greater than the maximum length in the other axial direction of the second loop.

22. The earbud of claim 21, wherein the metal rim formed to have a first length in the one axial direction is configured to resonate in a first frequency band, and
wherein the antenna pattern formed to have a second length, smaller than the first length, in the one axial direction is configured to resonate in a second frequency band broader than the first frequency band.

23. The earbud of claim 22, wherein
wherein the at least one ground connection portion includes a first ground connection portion and a second ground connection portion that are formed at the first point and the second point, respectively, on the internal surface of the metal rim, the first point and the second point being spaced apart in the one axial direction from each other, and
wherein the first ground terminal is connected, at the first point, to the first ground connection portion, and the second ground connection portion is connected, at the second point, to the second ground connection portion.

24. The earbud of claim 23, wherein the metal rim is formed in the shape of a closed loop,
wherein the first ground terminal and the second ground terminal are formed on one side border region of the front surface of the PCB, and
wherein the first ground connection portion and the second ground connection portion are formed on one side region of the metal rim in the shape of the closed loop.

25. The earbud of claim 24, wherein the antenna pattern is formed, in the shape of an open loop, to have a first end portion and a second end portion,
wherein the feeding terminal is formed, at a third point, on the front surface of the PCB, the third point being spaced apart in the other axial direction from the first point, and
wherein the feeding terminal is connected, at the third point, to the first end portion of the antenna pattern in the shape of the open loop.

26. The earbud of claim 25, wherein the antenna pattern is formed, in a third curved-line shape, in one portion of the lower region, the third curved-line shape of the antenna pattern corresponding to the second curved-line shape of the second loop in the one portion of the lower region, thereby enabling a signal from the antenna pattern to be coupled to the metal rim.

27. The earbud of claim 26, wherein the antenna pattern comprises:
a first sub-pattern formed to have a first straight-line length in the one axial direction, one end portion of the first sub-pattern being connected to the feeding terminal on the PCB;
a second sub-pattern formed to have a second straight-line length in the other axial direction, one end portion of the second sub-pattern being connected perpendicularly to the other end portion of the first sub-pattern; and
a third sub-pattern formed, in the third curved-line shape, to have a third straight-line, one end portion of the third sub-pattern being connected to the other end portion of the second sub-pattern,
wherein the one end portion of the first sub-pattern corresponds to the first end portion of the antenna pattern, and the other end portion of the third sub-pattern corresponds to the second end portion of the antenna pattern.

28. The earbud of claim 23, wherein the first ground connection portion and the second ground connection of the metal rim are formed in such a manner that the distance therebetween in the one axial direction ranges from 0 mm to 4 mm, and
wherein, as the distance to the second ground connection portion increases, the resonance frequency of the antenna structure increases.

29. The earbud of claim 23, wherein the first ground terminal is directly connected to the first ground connection portion or connected, at the first point, to the first ground connection portion, through a first matching element, and
wherein the second ground terminal is connected, at the second point, to the second ground connection portion through a second matching element.

30. The earbud of claim 29, wherein the first matching element connected to the first ground connection portion is a connection pattern with an impedance of 0 ohm,
wherein the second matching element connected to the second ground connection portion is formed as an inductor with an inductance of 1 nH to 5 nH, and
wherein the inductance of the second matching element increases, the resonance frequency of the antenna structure is decreased.

31. The earbud of claim 24, wherein the PCB is formed to have a third length in the one axial direction, and the metal rim in the shape of the closed loop is formed to have a third length greater than the first length in the one axial direction, and wherein the first low-end point on the lower end portion in the one axial direction of the metal rim overlaps the second low-end point on the lower end portion in one axial direction of the PCB.

32. The earbud of claim 22, further comprising:
a battery arranged on the rear surface of the PCB and configured to supply electric power to electronic components within the earbud;
a speaker arranged behind the rear surface of the battery in the accommodation space in the dielectric housing and configured to reproduce voice content received from a paired electronic device; and
a flexible printed circuit board (FPCB) connected to the PCB through the rear surface of the PCB and formed to surround the battery and the speaker.

33. The earbud of claim 32, wherein the FPCB includes a first accommodation space and a second accommodation space inside that are capable of accommodating the electronic components, and a first microphone and a second microphone are arranged in the first accommodation space and the second accommodation space, respectively,
wherein a control circuit on the PCB converts voice signals, received through the first microphone and the second microphone, into wireless signals, and
wherein the control circuit enables the wireless signals, resulting from the conversion, to be radiated through the feeding terminal and through the antenna structure including the antenna pattern and the metal rim, and thus enables the wireless signals, resulting from the conversion, to be transferred to the paired electronic device.

34. An earbud comprising:
a dielectric housing including a main body having a port and a protruding portion extending from the main body;
a printed circuit board (PCB) arranged in an accommodation space in the dielectric housing and including a feeding terminal and at least one ground terminal; and
a metal rim formed on the inward-facing portion of the internal surface of the dielectric housing or on the outward-facing portion of the external surface thereof, and connected to the feeding terminal and the at least one ground terminal,
wherein at least one ground connection portion of the metal rim is connected to the at least one ground terminal on the PCB, and
wherein a signal applied to the metal rim through the feeding terminal is radiated through an antenna structure formed as the metal rim,
wherein the metal rim comprises:
a first loop formed, in a first curved-line shape, in an upper region in a manner that is positioned in the one axial direction above the first point to which the first ground terminal is connected;
a second loop formed, in a second curved shape, in a lower region in a manner that is positioned in the one axial direction below the first point, and
a connection pattern connected to one point on the metal rim and arranged inward or outward from the second loop, in a manner that is spaced apart from the second loop,
wherein the metal rim radiates a signal in a first frequency band, due to the first loop and the second loop, and radiates a signal in a third frequency band broader than the first frequency band due to the connection pattern.

35. The earbud of claim 34, wherein the metal rim comprises:
a first sub-pattern formed to have a first pattern length in one axial direction, one end portion of the first sub-pattern being connected to the feeding terminal;
a second sub-pattern formed to have a second pattern length in the other axial direction, one end portion of the second sub-pattern being connected to the other end portion of the first sub-pattern; and
a loop pattern connected to an end portion of the at least one ground connection portion and the other end portion of the second sub-pattern and formed in the shape of a closed loop,
wherein the first sub-pattern and the second sub-pattern form a sub-pattern of the metal rim.

36. The earbud of claim 35, wherein the loop pattern on the metal rim formed to have a first length in the one axial direction is configured to resonate in a first frequency band,
wherein the sub-pattern on the metal rim formed to have a second length shorter than the first length in the one axial direction, and at least one region of the loop pattern are configured to resonate in a second frequency band broader than the first frequency band,
wherein the at least one ground terminal includes a first ground terminal and a second ground terminal formed, at a first point and a second point, respectively, on the front surface of the PCB, the first point and the second point being spaced apart from each other in the one axial direction,
wherein the at least one ground connection portion includes a first ground connection portion and a second ground connection portion, formed at the first point P1 and the second point P2, respectively, on one lateral surface of the metal rim, the first point and the second point being spaced apart from each other in the one axial direction,
wherein the first ground terminal is connected, at the first point, to the first ground connection portion, and
wherein the second ground terminal is connected, at the second point, to the second ground connection portion.

37. The earbud of claim 36, wherein the metal rim is formed in the shape of a closed loop,
wherein the first ground terminal and the second ground terminal are formed on one side border region of the front surface of the PCB,
wherein the first ground connection portion and the second ground connection portion are formed on one side region of the metal rim in the shape of the closed loop,
wherein the feeding terminal is formed, at a third point, on the front surface of the PCB, the third point being spaced apart in the other axial direction from the first point, and
wherein the feeding terminal is connected, at the third point, to the one end portion of the first sub-pattern of the metal rim.

38. The earbud of claim 34, further comprising:
an RF circuit operatively coupled to the antenna structure and transferring a wireless signal in a specific frequency band to the antenna structure; and
a processor operatively coupled to the RF circuit and configured to control the RF circuit,
wherein the processor controls the RF circuit in such a manner that a first wireless signal in a first frequency band is received through the antenna structure module, and,
wherein, when the signal quality of the first wireless signal is determined to be at or below a threshold value, the processor controls the RF circuit in such a manner that a second wireless signal in a second frequency band broader than the first frequency band is received from a host device through the antenna structure.
